(19) United States
(12) Patent Application Publication
(10) Pub. No.: US 2023/0033027 A1
(43) Pub. Date: Feb. 2, 2023

(54) WORKFLOW MANAGEMENT VIA A COMMUNICATION PLATFORM

(71) Applicant: Slack Technologies, Inc., San Francisco, CA (US)

(72) Inventors: Justin Rushing, Oakland, CA (US); Akshay Bakshi, Vancouver (CA); Faisal Yaqub, New York, NY (US); Michelle Jones, Louisville, KY (US)

(21) Appl. No.: 17/390,107

(22) Filed: Jul. 30, 2021

(51) Int. Cl. G06K 7/14; H04L 12/58

(52) U.S. Cl. CPC G06K 7/1417; H04L 51/08

(57) ABSTRACT

Techniques for documenting steps in a workflow via a communication channel of a communication platform based on code data input via a computing device are described herein. In an example, a user inputs a code, such as by scanning the code with a camera of a computing device. The communication platform receives the input and determines that a step in a workflow is complete. The communication platform identifies a communication channel associated with the workflow based on the input and generates a message to be transmitted via the communication channel, the message providing documentation of completion of a step in the workflow based on the input. In some examples, the communication platform receives additional data associated with the step in the workflow, such as images of an item and/or an environment associated with the step in the workflow and causes the additional data to be presented via the communication channel.

### TECHNICAL FIELD

Communication platforms are becoming increasingly more popular for facilitating work-related communications, such as for project collaboration within a single organization and/or across two or more organizations. In some instances, the communication platform can include particular workspaces and/or communication channels for particular projects, through which the users collaborating on the project may communicate. Often, the communication platform generates the workspaces and/or communication channels after receiving a request from a user to generate the workspace and/or channel. However, the manual request to generate the workspace and/or communication channel can be onerous for a user to complete in certain circumstances, such as when operating in a mobile environment. Adding to the burden on the user, in some instances, the user may also be required to manually complete workflow tasks within the workspace and/or the communication channel.

After the user requests a generation of a new workspace and/or communication channel and/or an association with an existing workspace and/or communication channel, an indicator associated therewith can be presented via an interface of the communication platform. Many users associate with dozens, if not hundreds, of workspaces and/or communication channels, each of which being represented on the interface with a respective indicator. However, some of the workspaces and/or communication channels may not be relevant to the user in certain circumstances, and a continuous presentation of the indicators associated therewith can render the interface unwieldy and difficult to manage.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates a block diagram illustrating an example system of computing devices usable to implement example techniques described herein.

FIG. 2 is a schematic view of an example user interface associated with a communication platform, as described herein.

FIGS. 3A-3C illustrate example user interfaces corresponding to a user checking in at a location and being granted access to particular communication channels associated with the location.

FIG. 4 illustrates an example process for enabling access to a communication channel based on a location, utilizing the techniques described herein.

FIG. 5 illustrates an example process for documenting completion, in a communication channel, of a step in a workflow based on an input via a communication application, utilizing the techniques described herein.

FIG. 6 illustrates an example process for updating a user interface of a communication application based on an indication of selection of a code, utilizing the techniques described herein.

FIG. 7 illustrates an example process for presenting a completion of a step in a workflow via a communication channel based on an indication of selection of a code, utilizing the techniques described herein.

FIG. 8 illustrates an example process for documenting, via a communication channel, a completion of a step in a workflow with an image of an item, utilizing the techniques described herein.

FIG. 9 illustrates an example process for updating a third-party document based on an indication of selection of a code, utilizing the techniques described herein.

FIG. 10 illustrates an example process for optimizing a communication application based on available bandwidth, utilizing the techniques described herein.

### DETAILED DESCRIPTION

Techniques for prompting users to perform steps in a workflow and/or documenting steps in a workflow via a communication channel of a communication platform based on input received via a computing device associated with the communication platform are described herein. The communication platform can be a group-based communication platform, a channel-based messaging platform, and/or any other platform for facilitating communication between and among users. In an example, a first user can scan a code, such as via a camera or other sensor of a computing device. The communication platform receives the input corresponding to the scanned code and determines that the code is associated with a particular step in a workflow. In some examples, the communication platform can determine that the particular step is a first step, and can generate a communication channel corresponding to the workflow. In some examples, the communication platform can identify an existing communication channel corresponding to the workflow. Based on the input corresponding to the scanned code, the communication platform can cause a presentation of a message via the newly generated or existing communication channel, the message providing an indication that the step in the workflow is complete. In at least one example, the message can provide documentation of completion of a step in the workflow, such as with a timestamp and/or location associated with the step. In some examples, the communication platform can receive additional data associated with a step in the workflow, such as images of items and/or an environment associated with the step in the workflow. The communication platform can cause the additional data to be presented via the newly generated or existing communication channel associated with the workflow.

In existing technologies, a user can manually generate a communication channel, such as by requesting the generation thereof via an interface of the communication platform. After generation of a communication channel, the user can then manually generate a message to share with one or more other users via the communication channel. The manual generation of the message can include selecting an icon associated with drafting a message, inputting the data to include in the message, and then selecting a send icon to cause the message to be transmitted via the communication channel. In examples in which a communication channel is associated with a particular workflow or sequence of steps in processing a unit of work from initiation to completion, each user associated with the particular workflow manually generates and transmit messages including data associated with the workflow, such as indications of completion of various steps in the workflow. The manual input of data can require a significant amount of time and computing resources, which can lead to a negative user experience and excessive use of computing resources. The manual input can additionally be subject to human error, such as if a user forgets to input an item of data in a message associated with the workflow.

The techniques described herein provide a technical solution to a technical problem of enabling automatic workflow updates based on scanned codes input via a communication application. As discussed above, a user can manually generate a communication channel to document completion of steps in a workflow. The workflow can include a sequence of steps in a project or a particular job from initiation to completion. The sequence of steps can be performed by one or more people, each of which can be granted access to the communication channel. However, the manual input of data into messages for documentation via the communication channel can be time consuming, can result in an excessive use of computing resources, and can also potentially result in critical data being omitted, such as due to human error. To solve this technical problem related to data management, this application describes a means by which data associated with a workflow can be automatically input into a communication channel in response to receiving an indication of selection of one or more codes from one or more user computing devices via a communication application. The code can include a QR code, a bar code, or other code or image including data that is configured to be input via a computing device and processed by the communication platform. The techniques described herein can significantly reduce the number of operations, and consequently the number of computations and the amount of network bandwidth, required to implement the workflow. In some instances, the techniques described herein may also enable implementation of workflows by workers in the field and/or using computing devices that were previously not suitable to implement such workflows (e.g., devices without keyboards, mice, or other traditional input mechanisms, devices with limited connectivity, etc.).

In various examples, a first user can access a first instance of a communication application on a first user computing device. The first user can input data associated with a first code utilizing an input/output device of the first user computing device, such as a camera, microphone, or the like. In at least one example, the first user can input the data by scanning a QR code, bar code, or other machine-readable code. Though this is merely an illustrative example and other examples are contemplated herein, such as verbally inputting a code via a microphone, or the like.

In various examples, the communication platform can receive the input and can identify a workflow associated with the first code. The workflow can include a sequence of processes (e.g., steps) through which a piece of work passes from initiation to completion. In some examples, the communication platform can receive the input and can identify information about the workflow. The information can include a particular step in the workflow, a status associated with the particular step (e.g., complete, in process, etc.), a time associated with the particular step (e.g., time of input, etc.), a location of an item corresponding to the workflow, or the like. As a non-limiting example, the communication platform can receive an input of a first code corresponding to a location of an item in a shipping workflow. The communication platform can identify, based on the first code, information associated with the shipping workflow, such as a particular step in the shipping workflow (e.g., item packaged, item weighed, shipping label printed, item secure for delivery, item picked up by delivery person, item delivered to customer, etc.), a time, and location associated with the particular step.

In various examples, the communication platform can determine, based on the input, that a particular step in the workflow is complete. In some examples, the communication platform can determine that additional information (e.g., photograph, video, description of an item and/or condition, security, etc. thereof, etc.) is required to complete the particular step. In such examples, the communication platform can cause a request for additional information to be presented to the first user on the first user computing device via the communication application. The request for additional information can include a pop-up notification indicating the particular additional information that is requested. Continuing the example of the shipping workflow, the request for additional information can include a request for an image of the item, such as to document a condition of the item and/or packaging associated therewith.

In various examples, the communication platform can generate a message including the information and/or the additional information, such as to indicate that the particular step in the workflow is complete. In various examples, the communication platform can cause the message to be presented via a communication channel associated with the workflow. In some examples, the communication platform can identify an existing communication channel associated with the workflow and can transmit the message via the existing communication channel. In some examples, the communication platform can determine that the code is associated with a first step in a workflow and/or that a communication channel associated with the workflow does not yet exist. In such examples, the communication platform can generate the communication channel. In various examples, the communication platform can identify one or more users associated with the communication channel, such as the first user and/or other users associated with the workflow, and can associate the user(s) with the communication channel.

In various examples, the communication platform can be configured to identify the particular step in the workflow that is associated with the first code and identify a second user associated with a next step in the workflow. In some examples, the communication platform can associate the second user with the message, such as by including an @mention of the second user or otherwise tagging the second user in the message. In some examples, the communication platform can generate and send a direct message to a user account associated with the second user, such as to inform the second user that the particular step is complete and/or of a pending task to complete (e.g., the next step).

In various examples, the communication platform can be configured to identify the user(s) associated with the workflow based on receiving inputs corresponding to a work shift. In some examples, the communication platform can be configured to receive, prior to receiving the input corresponding to the workflow, another input from a user computing device corresponding to a work shift code. The work shift code can be a code (e.g., QR code, bar code, digital code, or other machine-readable code) associated with a user clocking in and/or clocking out on a work shift, on a break, or the like. The work shift code can be associated with a particular job (e.g., area of responsibility, tasks, etc.), location, status (e.g., working, on break, at lunch, on-call, etc.), or the like. In various examples, in response to receiving, from the user computing device associated with a particular user, an input corresponding to the work shift code, the communication platform can determine a working status associated with the particular user. For example, a shipping warehouse can include a first check-in code associated with a first area of the shipping warehouse that corresponds to packaging items for delivery. In response to receiving, from the first user computing device of the first user, an indication of selection of the first check-in code (e.g., input corresponding to the first check-in code), the communication platform can determine that the first user is on shift in the first area packaging items for delivery.

In some examples, based on receiving, from the user computing device of the particular user, an indication of selection of a particular check-in work shift code, the communication platform can grant the particular user access to communication channels associated with the particular check-in work shift code. In such examples, the communication platform can identify the communication channels associated with the particular check-in work shift code and can cause indicators associated therewith to be presented on the user computing device via an instance of the communication application. Continuing the example from above, the first user can scan the first check-in code associated with the first area corresponding to packaging items for delivery. The communication platform can identify one or more communication channels associated with the first area, such as communication channels associated with items to be packaged for delivery. The communication platform can associate the first user with the communication channel(s) and can provide indicator(s) associated therewith to be presented to the user via the instance of the communication application.

In various examples, based on receiving check-in work shift code inputs from one or more users and associating the user(s) with corresponding communication channel(s), the communication platform can be configured to determine users associated with a particular workflow and/or steps associated with the particular workflow. For example, a shipping warehouse can include a first check-in code associated with a first area of the shipping warehouse (e.g., product packaging) and a second check-in code associated with a second area of the shipping warehouse (e.g., associated with delivery). The communication platform can receive, from the first user computing device, a first input corresponding to the first check-in code associated with the first area, and can determine that the first user is on-shift packaging products. The communication platform can receive, from a second user computing device associated with the second user, a second input corresponding to a second check-in code associated with the second area, and can determine that the second user is on-shift delivering products. After receiving, from the first user computing device, an indication of selection of a code corresponding to a completion of product packaging (e.g., first step complete), the communication platform can determine that the next step in the workflow is delivery. The communication platform can identify the second user and can @mention (or otherwise tag) the second user in a message transmitted via a communication channel corresponding to the workflow, informing the second user that the first step in the workflow is complete and a second step is pending. Additionally or alternatively, the communication platform can send a direct message to the second user to provide workflow status information.

In some examples, the communication platform can receive a work shift code, such as a check-in code, and can determine that the work shift code is associated with a limited bandwidth location (e.g., location with bandwidth less than 2 Mbps, 4 Mbps, etc., location with limited cellular connectivity). In some examples, based on a determination that the work shift code is associated with the limited bandwidth location, the communication platform can modify the communication application and/or data transmitted based on the limited bandwidth. In such examples, the communication platform can be configured to optimize the communication application for the limited bandwidth environment. As non-limiting examples, a modification to the communication application and/or data transmitted therethrough can include collapsing images, suppressing animations, breaking files into segments for transmission, compressing audio files, and the like.

In some examples, a modification to the communication application and/or data transmitted therethrough can include modifying the workspaces, communication channels, and/or direct messaging instances that are updated and/or presented via the communication application. In various examples, the communication platform can identify a first set of workspaces, communication channels, and/or direct messaging instances that are associated with the location and a second set of workspaces, communication channels, and/or direct messaging instances that are not associated with the location. In such examples, the communication platform can suppress updates associated with the second set of workspaces, while providing updates associated with the first set of workspaces. In various examples, by suppressing the updates associated with the second set of workspaces and/or otherwise optimizing for limited bandwidth environments, the communication platform can be configured to improve the functioning of the user computing device.

Additionally, the techniques described herein are further configured to improve the functioning of the user computing device by granting access to particular communication channels based on a user checking into a particular location. For example, and as described above, a user can check-in to a work location, such as by scanning a check-in work shift code. Based on the input of the check-in work shift code, the communication platform can enable the user access to particular communication channel(s) associated with a job associated with the check-in work shift code. The communication platform can cause indicators associated with the particular communication channel(s) to be presented via the communication application. In various examples, the communication application can subsequently receive an input corresponding to a check-out work shift code, indicating that the user is no longer on shift. Based on the input corresponding to the check-out work shift code, the communication application can remove one or more indicators associated with the workspaces, communication channels, and/or direct messaging instances associated with the job from an interface associated with the communication application. In some examples, removing the one or more indicators associated with the workspaces, communication channels, or direct messaging instances causes the user to lose access or become disassociated with the associated workspaces, communication channels, or direct messaging instances. In some examples, the workspaces, communication channels, or direct messaging instances may be archived if no longer needed. In some examples, archiving a communication channel causes a user to become disassociated with the communication channel such that the user no longer has access to the data in the communication channel. In some examples, the workspaces, communication channels, and/or direct messaging instances can be accessible to the user, such as via a search function. In some examples, access to the workspaces, communication channels, and/or direct messaging instances can be revoked. In such examples, the user can be disabled from accessing the workspaces, communication channels, and/or direct messaging instances associated with the job after inputting a check-out work shift code. Accordingly, the communication platform can limit access to particular work-related workspaces, communication channels, and/or direct messaging instances based on a working status of the user. As such, the communication platform can improve the functioning of the user computing device by limiting access to workspaces, communication channels, and/or direct messaging instances when they are relevant to the user.

Further, a limitation of access to work-related workspaces, communication channels, and/or direct messaging instances based on a determination that a user is at work (e.g., on shift, at a work location, etc.) can increase the security of information transmitted therein. As such, the techniques described herein can improve information security provided by the communication application. Additionally, the techniques described herein improve performance of one or more computing devices by reducing an amount of content sent over a network. For instance, in a traditional communication platform system, workspaces, communication channels, and/or direct messaging instances to which a user is associated can be accessible to the user via a communication application at all times. Unlike these traditional methods, the communication platform can associate particular workspaces, communication channels, and/or direct messaging instances with particular locations, and can grant access thereto based on a location of the user and/or a user computing device associated therewith. The communication platform can thus send updates associated with the particular workspaces, communication channels, and/or direct messaging instances to the user computing device at times when they are relevant to the user (e.g., when the user is at work). Thus, the techniques described herein can reduce the amount of content (e.g., updates, etc.) sent over the network. As such, the quantity of data sent over the network can be reduced and the amount of bandwidth available can be increased.

Furthermore, the techniques described herein provide a better user experience for users associated with a communication platform. As discussed above, traditionally, a user can associate with a plurality of workspaces, communication channels, and/or direct messaging instances of a communication platform. Once associated with the plurality of workspaces, communication channels, and/or direct messaging instances, indicator(s) associated therewith can be continuously presented to the user via an interface of the communication platform. However, some of the workspaces, communication channels, and/or direct messaging instances may not be applicable to the user at certain times, and may clutter the interface and/or provide notifications that are not relevant to the user. The techniques described herein provide a means by which select workspaces, communication channels, and/or direct messaging instances can be accessible to the user when applicable, and can be removed from the interface (e.g., access revoked, indicator hidden, etc.) when not applicable (e.g., user away from a location, not at work, etc.). As such, the techniques described herein can provide an enhanced user experience.

These and other aspects are described further below with reference to the accompanying drawings. The drawings are merely example implementations and should not be construed to limit the scope of the claims. For example, while some examples are illustrated in the context of a user interface for a mobile device, the same or similar techniques can be implemented using any computing device and the user interface can be adapted to the size, shape, and configuration of the particular computing device.

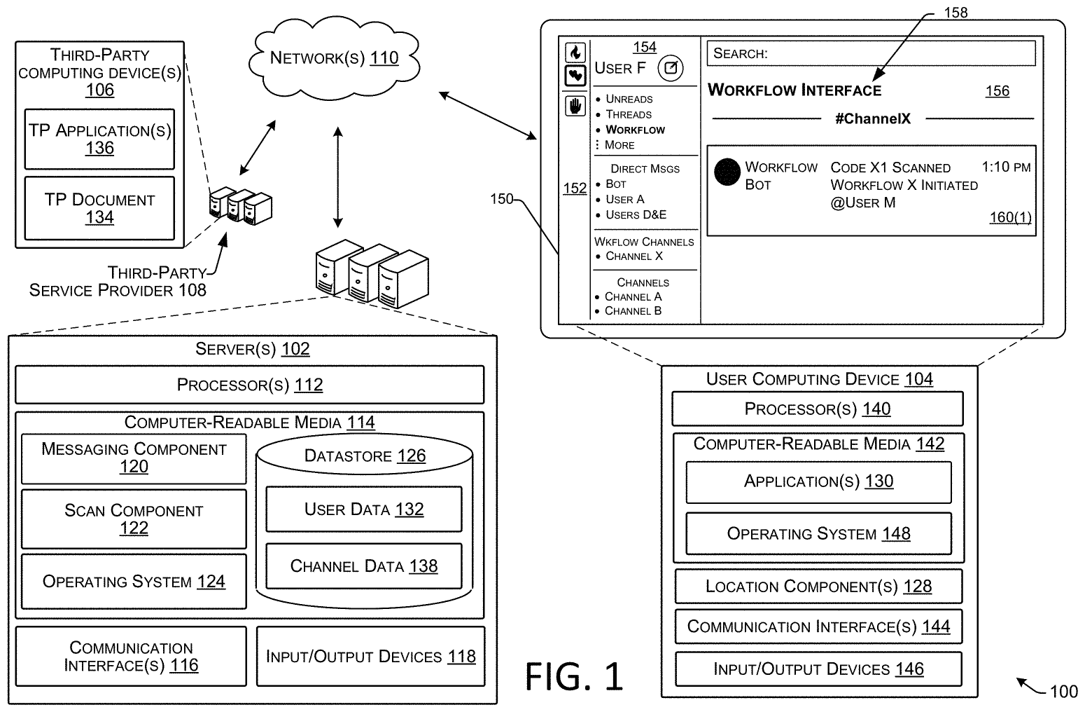

FIG. 1 illustrates an example system 100 for performing techniques described herein. In at least one example, the example system 100 can be associated with a communication platform that can leverage a network-based computing system to enable users of the communication platform to exchange data. In at least one example, the communication platform can be “group-based” such that the platform, and associated systems, communication channels, messages, and/or virtual spaces, have security (that can be defined by permissions) to limit access to a defined group of users. In some examples, such groups of users can be defined by group identifiers, which can be associated with common access credentials, domains, or the like. In some examples, the communication platform can be a hub, offering a secure and private virtual space to enable users to chat, meet, call, collaborate, transfer files or other data, or otherwise communicate between or among each other. In various examples, each group can be associated with a workspace, enabling users associated with the group to chat, meet, call, collaborate, transfer files or other data, or otherwise communicate between or among each other in a secure and private virtual space. In some examples, members of a group, and thus a workspace, can be associated with a same organization. In some examples, members of a group, and thus a workspace, can be associated with different organizations (e.g., entities with different organization identifiers).

In at least one example, the example system 100 can include one or more server computing devices (or “server(s)”) 102. In at least one example, the server(s) 102 can include one or more servers or other types of computing devices that can be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

In at least one example, the server(s) 102 can communicate with a user computing device 104 and/or one or more third-party computing devices 106 associated with a third-party service provider 108 (e.g., third-party resource) via one or more network(s) 110. That is, the server(s) 102, the user computing device 104, and the third-party computing device(s) 106 can transmit, receive, and/or store data (e.g., content, information, or the like) using the network(s) 110, as described herein. The user computing device 104 and the third-party computing device(s) 106 can be any suitable type of computing device, e.g., portable, semi-portable, semi-stationary, or stationary. Some examples of the third-party computing device(s) 106 can include a server computing device, such as that described above with regard to the server(s) 102, a desktop computing device, a terminal computing device, or the like.

Some examples of the user computing device 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. While a single user computing device 104 is shown, in practice, the example system 100 can include multiple (e.g., tens of, hundreds of, thousands of, millions of) user computing devices. In at least one example, user computing devices, such as the user computing device 104, can be operable by users to, among other things, access communication services via the communication platform. A user can be an individual, a group of individuals, an employer, an enterprise, an organization, or the like.

The network(s) 110 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 110 are well known and are not discussed herein in detail.

In at least one example, the server(s) 102 can include one or more processors 112, computer-readable media 114, one or more communication interfaces 116, and input/output devices 118. Though not illustrated in FIG. 1, the third-party computing device(s) 106 can additionally include one or more processors, such as processor(s) 112, computer-readable media, such as computer-readable media 114, communication interface(s) 116, such as communication interface(s) 116, input/output devices, such as input/output devices 118.

In at least one example, each processor of the processor(s) 112 can be a single processing unit or multiple processing units and can include single or multiple computing units or multiple processing cores. The processor(s) 112 can be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) 112 can be one or more hardware processors and/or logic circuits of any suitable type specifically programmed or configured to execute the algorithms and processes described herein. The processor(s) 112 can be configured to fetch and execute computer-readable instructions stored in the computer-readable media, which can program the processor(s) to perform the functions described herein.

The computer-readable media 114 can include volatile and nonvolatile memory and/or removable and non-removable media implemented in any type of technology for storage of data, such as computer-readable instructions, data structures, program modules, or other data. Such computer-readable media 114 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a computing device. Depending on the configuration of the server(s) 102, the computer-readable media 114 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 114 can be used to store any number of functional components that are executable by the processor(s) 112. In many implementations, these functional components comprise instructions or programs that are executable by the processor(s) 112 and that, when executed, specifically configure the processor(s) 112 to perform the actions attributed above to the server(s) 102. Functional components stored in the computer-readable media can optionally include a messaging component 120, a scan component 122, an operating system 124, and a datastore 126.

In at least one example, the messaging component 120 can process messages between users. That is, in at least one example, the messaging component 120 can receive an outgoing message from a user computing device 104 and can send the message as an incoming message to a second user computing device 104. The messages can include direct messages sent from an originating user to one or more specified users and/or communication channel messages sent via a communication channel from the originating user to the one or more users associated with the communication channel. The communication channel, or virtual space, can be a data route used for exchanging data between and among systems and devices associated with the communication platform. In at least one example, the messaging component 120 can establish a communication channel between and among various user computing devices, allowing the user computing devices to communicate and share data between and among each other. In at least one example, the messaging component 120 can manage such communications and/or sharing of data. In some examples, data associated with a communication channel can be presented via a user interface.

In various examples, the messaging component 120 can be communicatively coupled to the scan component 122. In various examples, the scan component 122 can be configured to receive, from the user computing device 104, data associated with a code. The code can include a QR code, bar code, image, or other machine-readable code including data. The data can include an indication of selection of the code, such as by a user associated with the user computing device 104. In some examples, the data can include a time associated with a scan or an input of the code and/or a user account (e.g., the user) associated with the scan or the input. In various examples, the scan component 122 can be configured to identify characteristics associated with the code, based in part on the data. The characteristic(s) can include a location, a work shift status (e.g., check-in, check-out, on break, at lunch, etc.), a workflow, a step in a workflow, one or more communication channels associated with the code and/or the workflow, a bandwidth limitation associated with the code, or the like. For example, the scan component 122 can be configured to receive data associated with a first code and determine that an input of the first code (e.g., indication of selection of the first code) is associated with a user checking in to work. For another example, the scan component 122 can be configured to receive data associated with a second code and determine that an input of the second code is associated with a completion of a first step in a workflow.

In various examples, the scan component 122 can provide the messaging component 120 with the data and/or characteristics associated with the code. Based on the data and/or the characteristics, the messaging component 120 can perform one or more actions. In some examples, the action(s) can include enabling and/or disabling access to a set of virtual spaces based on the code. The virtual spaces can include one or more workspaces, communication channels, and/or direct messaging instances that are associated with the code. For example, in response to receiving an indication of selection of a first code at a first time, the scan component 122 can determine that the user has checked in to work. The scan component 122 can send the messaging component 120 an indication that the user has checked in to work at a location determined based on the data and the characteristics associated with the first code. The messaging component 120 can then enable the user access to a set of communication channels associated with the location. The messaging component 120 can cause indicators associated with the set of communication channels to be presented on an interface of the communication application. At a second time after the first time, the scan component can receive an indication of selection of a second code, and can determine, based on data and characteristics associated therewith, that the user has checked out of work at the location. The scan component 122 can send the messaging component 120 an indication that the user has checked out of work at the location and the messaging component 120 can cause the indicators associated with the set of communication channels to be removed from the interface. In some examples, the messaging component 120 can enable access to one or more of the set of channels via a search or other function of the interface. In some examples, the messaging component 120 can revoke the user access to the set of channels based on the indication that the user has checked out of work.

In some examples, the action(s) can include limiting updates and/or data transmitted to the user computing device 104 based on code and/or a location associated with the user computing device. In various examples, the scan component 122 can identify a location based on the data and/or characteristics associated with a code. In such examples, the scan component 122 can receive data associated with a code (e.g., scanned code) from the user computing device 104, and identify the location based on characteristics of the code (e.g., a location associated with the code). In some examples, the scan component 122 can be configured to identify a location of the user computing device 104 based on location data received therefrom, such as via a location component 128 (e.g., GPS, Wi-Fi network identifier, triangulation, gyroscopes, inertial measurement units, etc.). In such examples, the user computing device 104 can send the location data to the scan component 122, concurrently with or separately from the data associated with the code. In various examples, the scan component 122 can identify the location as a limited bandwidth location (e.g., location with bandwidth less than 2 Mbps, 4 Mbps, etc., location with limited cellular connectivity) and can provide the information about the location to the messaging component 120. In some examples, based on a determination that the location is a limited bandwidth location, the messaging component 120 can modify data transmitted to the user computing device 104, such as via an application 130. In such examples, the messaging component 120 can be configured to optimize performance for the limited bandwidth environment.

In some examples, the messaging component 120 can identify a set of virtual spaces associated with the location. The messaging component 120 can provide updates (e.g., new messages and other data transmitted, reaction emojis, etc.) to the set of virtual spaces associated with the location, while withholding updates to other virtual spaces that are not associated with the location. In some examples, the messaging component 120 can identify one or more virtual spaces that are important to the user (e.g., starred, favorites, etc.), such as based on user preferences stored in user data 132, and can provide updates to the virtual space(s) that are important to the user along with the set of virtual spaces associated with the location. In various examples, by limiting the number of virtual spaces in which updates are provided, the messaging component 120 can provide additional bandwidth for messages to be delivered via the set of virtual spaces associated with the location and/or the virtual space(s) that are important to the user.

Additionally or alternatively, the messaging component 120 can receive an indication that the user computing device is operating in a limited bandwidth environment and can modify data transmitted via one or more virtual spaces. In some examples, the messaging component 120 can collapse images, suppress animations, split files into segments (e.g., <2 megabytes, <4 megabytes or less, etc.) for transmission, compress audio files, and the like. In various examples, the messaging component 120 can continue to modify the data transmitted via the virtual space(s) and/or can provide updates associated with select virtual space(s) until the messaging component 120 receives an indication that the user computing device is no longer operating in the limited bandwidth environment. In some examples, the messaging component 120 can receive the indication from the scan component 122, such as in response to receiving an indication that the user scanned a code associated with checking out of the limited bandwidth location, a code associated with non-limited bandwidth location (e.g., another location that is not bandwidth limited), and/or an indication from the location component 128 that the user computing device 104 is no longer associated with the limited bandwidth location.

In some examples, the messaging component 120 can receive, from the scan component 122 and/or from the user computing device 104, the data and/or characteristics associated with a code, such as based on a user scanning or otherwise inputting data associated with the code. In response to receiving the data and/or characteristics, the messaging component 120 can perform the action of identifying a workflow associated with the code. The workflow can include a sequence of steps in a project or a particular job (e.g., a unit of work) from initiation to completion. The sequence of steps can be performed by one or more users. In some examples, each of the user(s) can have associated therewith a user computing device 104 with a respective instance of the communication application 130. In various examples, the messaging component 120 can identify a communication channel associated with the workflow. In such examples, each of the user(s) associated with the workflow can have permissions to access the communication channel, such as for transmitting and receiving messages via the respective instances of the communication application 130.

In various examples, based on the data and/or the characteristics, the messaging component 120 can determine a step in the workflow that is associated with the code. In some examples, the messaging component 120 can determine, based on the indication of selection of the code (e.g., indication that the user has scanned or otherwise input of the code), that the step in the workflow is complete. In various examples, the messaging component 120 can generate and transmit a message including data and/or characteristics associated with the code and/or the selection thereof. In various examples, the generation and transmission of the message can be performed by the messaging component 120 automatically, such as without input from a user associated with the associated communication channel. For example, the messaging component 120 can receive an indication that a first user has selected a first code with the user computing device 104. The messaging component 120 can identify a step in a workflow and a communication channel associated with the code. The messaging component can generate a message indicating that the step in the workflow was completed at a particular time (e.g., 8:03 am, 1:26 pm, etc.), at a particular location, and by the first user.

In various examples, the messaging component 120 can determine that additional information is requested for documentation. In such examples, the messaging component 120 can identify the workflow and/or step associated with the code and can determine that documentation associated with the workflow and/or step of the workflow includes additional information beyond the data and/or characteristics associated with the code. For example, documentation of a workflow associated with packaging and delivering an item can include an image of the item and/or packaging associated therewith at each step in the workflow. In various examples, based on a determination that the additional information is requested for documentation, the messaging component 120 can send a request for the additional information to the associated user computing device 104. That is, the messaging component 120 can cause the request to be presented on a display of the user computing device, such as via an instance of the communication application 130. In some examples, the request can include a means by which the user can respond to provide the additional information. Continuing the example from above, the messaging component can cause a request for an image of the item to be presented on the user computing device 104. The user can select a camera option associated with the communication application 130 and/or the request, to enable the communication application 130 to access the camera. The user can capture an image of the item and send to the messaging component 120 via the communication application. In various examples, the messaging component 120 can receive a response to the request (e.g., the image) and can cause the image to be transmitted via the communication channel, such as in association with the message and/or in a separate message. In examples in which the additional information is presented in a separate message, the separate message can be transmitted via the communication channel and/or a thread associated with the original message documenting the step in the workflow.

Additionally or alternatively, the first user can opt to provide additional information, such as without receiving a request from a communication channel. In some examples, the first user can manually generate a message to be transmitted via the communication channel, such as in a thread of the communication channel associated with the automatically generated message (e.g., message documenting step in the workflow). For example, the first user can identify an imperfection in a package during a packaging and delivery process. The first user can input a description of the imperfection and/or access the camera via the communication application 130, such as to capture an image of the imperfection. In such an example, the first user can document a time that the imperfection was identified and/or details regarding the imperfection.

In various examples, based on the data and/or the characteristics, the messaging component 120 can identify the workflow associated with the code and can determine that a communication channel associated with the workflow has not yet been created. In some examples, the determination that the communication channel has not yet been created can be determined based on a determination that the code is associated with a first step in the workflow. In various examples, based on a determination that the communication channel has not yet been created, the messaging component 120 can generate a communication channel associated with the workflow. In various examples, the messaging component 120 can identify one or more users to be associated with the workflow. In some examples, the messaging component 120 can identify the user(s) based on receiving inputs corresponding to a work shift, such as based on receiving an indication of selection of a check-in work shift code, as discussed above. In such examples, the messaging component 120 can identify the user(s) based on job position(s) and/or title(s) associated with the user(s) and/or the work shift codes, check-in location(s) (e.g., associated with the work shift code), and the like. For example, a user can scan a check-in work shift code associated with delivering packages (e.g., delivery position, location associated with delivery crew, etc.). Based on a determination that package delivery is associated with a workflow associated with packaging and delivering an item, the messaging component can associate the user with a newly generated communication channel associated with the packaging and delivery workflow.

In some examples, based on a determination that a particular step in a workflow is complete, such as based on data and/or characteristics associated with a code scanned by a first user, the messaging component 120 can be configured to identify a second user associated with a next step in the workflow. In some example, the messaging component 120 can identify the second user based on a position and/or title, a work location, a current location associated with the second user (e.g., based on location data associated with a user computing device), a work status associated with the second user (e.g., on-shift, not on a break, etc.), and the like.

In some examples, the messaging component 120 can associate the second user (e.g., a user account associated with the second user) with the message transmitted via the communication channel, such as by including an @mention of the second user or otherwise tagging the second user in the message. In some examples, the messaging component 120 can generate and send a direct message to a user account associated with the second user, such as to inform the second user that the particular step is complete and/or of a pending task to complete (e.g., the next step).

Additionally, in some examples, the action(s) performed by the messaging component 120 in response to receiving the data and/or characteristics of the code (e.g., from the scan component 122), can include identifying a third-party document 134 associated with the code and/or the workflow associated therewith. The third-party document 134 can include a document configured to store data associated with one or more workflows. That is, the third-party document 134 can provide a means of documenting data associated with steps of the workflow as the steps are completed. In various examples, the messaging component 120 can identify the third-party document 134 associated with the workflow and/or the communication channel and can cause the data and/or characteristics of the code to be stored in association with the third-party document 134. In such examples, messaging component 120 can cause workflow status information to be stored in association with the third-party document 134 based on an indication of selection of a code associated with the workflow. In various examples, the workflow status information can also be stored in channel data 138, in addition to other data corresponding to the communication channel associated with the code and/or the workflow, such as messages transmitted via the communication channel, reactions to messages, and the like.

In some examples, the third-party document 134 can be managed by a third-party service provider 108 and/or stored in association with a third-party computing device 106. In some examples, the messaging component 120 can cause the third-party document 134 to be updated and/or can access information associated therewith utilizing one or more application programming interfaces (APIs). In some examples, the third-party document 134 can be associated with a third-party application 136 that is accessible via the application(s) 130. In such examples, users associated with a particular workflow and/or communication channel associated therewith can access the third-party document 134, such as to identify a status of the workflow. In some examples, third-party document 134 can provide a means by which users not associated with the communication channel and/or communication platform can determine a status of the workflow. For example, a workflow associated with packaging and delivering an item can be associated with a communication channel. A consumer who purchased the item may desire to view a status of the order (e.g., status of the workflow). In examples in which the user is not associated with the communication channel and/or the communication platform, the user can be granted access to the third-party document 134 that includes the workflow data, such as to view the status of the order. By automatically transmitting messages via a communication channel associated with a workflow and updating an identified third-party document 134 associated with the workflow, the messaging component 120 can ensure that real-time or near real-time workflow status information is continually available to users associated with the workflow.

Further, as mentioned above, the messaging component 120 can store messages sent between user computing devices in the datastore 126, such as in channel data 138. In at least one example, the datastore 126 can be configured to store data that is accessible, downloadable, manageable, and updatable. Additionally, the messaging component 120 can store user data 132 associated with users of the communication platform, such as user preferences regarding preferred workspaces, communication channels, direct messaging instances (e.g., virtual spaces to be updated in limited bandwidth environments), user data (e.g., job position, title, organization information, work schedule, working location(s), demographic data, etc.), virtual spaces the user has permissions to access, and the like. In some examples, the datastore 126 can be integrated with the server(s) 102, as shown in FIG. 1. In other examples, the datastore 126 can be located remotely from the server(s) 102 and can be accessible to the server(s) 102 and/or user computing device(s), such as the user computing device 104. Additional or alternative data can be stored in the datastore 126 and/or in one or more other data stores.

In some examples, the datastore 126 can be partitioned into discrete items of data that can be accessed and managed individually (e.g., data shards). Data shards can simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, individual users can be associated with a database shard within the datastore 126 that stores data related to a particular user account. For example, communication platform user data 132 associated with a particular user account can be stored in a particular database shard.

In at least one example, the channel data 138 can store data associated with individual communication channels. In at least one example, the messaging component 120 can establish a communication channel between and among various user computing devices, allowing the user computing devices to communicate and share data between and among each other. In at least one example, a communication channel identification may be assigned to a communication channel, which indicates the physical address in the channel data 138 where data related to that communication channel is stored. A communication channel may be “public,” which may allow any user within an organization (e.g., associated with an organization identifier) to join and participate in the data sharing through the communication channel, or a communication channel may be “private,” which may restrict data communications in the communication channel to certain users or users having particular roles (e.g., managers, administrators, etc.). In some examples, a communication channel may be “shared,” which may allow users associated with different organizations (e.g., entities associated with different organization identifiers) to join and participate in the data sharing through the communication channel. For example, a workflow may include steps performed by two different organizations, such as a first organization responsible for packaging an item for shipment and a second organization responsible for delivering the item to a consumer. In such an example, a communication channel associated with the workflow can be a shared channel between the first organization and the second organization. Shared channels may be public such that they are accessible to any user of either organization, or they may be private such that they are restricted to access by certain users or users having particular roles from both organizations.

In at least one example, the operating system 124 can manage the processor(s) 112, computer-readable media 114, and/or hardware, software, etc. of the server(s) 102.

The communication interface(s) 116 can include one or more interfaces and hardware components for enabling communication with various other devices (e.g., the user computing device 104, third-party computing device(s) 106, etc.), such as over the network(s) 110 or directly. In some examples, the communication interface(s) 116 can facilitate communication via Websockets, APIs (e.g., using API calls), HyperText Transfer Protocols (HTTPs), etc.

The server(s) 102 can further be equipped with various input/output devices 118 (e.g., I/O devices). Such I/O devices 118 can include a display, various user interface controls (e.g., buttons, joystick, keyboard, mouse, touch screen, etc.), audio speakers, connection ports and so forth.

In at least one example, the user computing device 104 can include one or more processors 140, computer-readable media 142, one or more location components 128, one or more communication interfaces 144, and input/output devices 146.

In at least one example, each processor of the processor(s) 140 can be a single processing unit or multiple processing units, and can include single or multiple computing units or multiple processing cores. The processor(s) 140 can include any of the types of processors described above with reference to the processor(s) 112 and can be the same as or different than the processor(s) 112.

The computer-readable media 142 can include any of the types of computer-readable media 142 described above with reference to the computer-readable media 114 and can be the same as or different than the computer-readable media 114. Functional components stored in the computer-readable media can optionally include one or more applications 130 and an operating system 148.

The application(s) 130 can include a mobile application, a web application, and/or a desktop application. In some examples, one or more of the application(s) 130 can include an instance of a third-party application 136, which can be provided by the third-party service provider(s) 108. In at least one example, at least one application 130 can be provided by the communication platform or which can be an otherwise dedicated application. In some examples, individual user computing devices associated with the system 100 can have an instance or versioned instance of the application(s) 130, which can be downloaded from an application store, accessible via the Internet, or otherwise executable by the processor(s) 140 to perform operations as described herein. That is, the application(s) 130 can be an access point, enabling the user computing device 104 to interact with the server(s) 102 to access and/or use communication services available via the communication platform. In at least one example, the application(s) 130 can facilitate the exchange of data between and among various other user computing devices, for example via the server(s) 102. In at least one example, the application(s) 130 can access an I/O device 146 of the user computing device 104, such as to receive an input of a code (e.g., scanned code, verbally input code, etc.) corresponding to a workflow and/or a communication channel. The application(s) 130 can be configured to provide the input to the server(s) 102 utilizing the communication interface(s) 144. In at least one example, the application(s) 130 can present user interfaces, as described herein. In at least one example, a user can interact with the user interfaces via touch input, keyboard input, mouse input, spoken input, or any other type of input. In some examples, user interfaces, as described herein, and/or other operations can be performed via a web browser or other access mechanism.

A non-limiting example of a user interface 150 is shown in FIG. 1. As illustrated in FIG. 1, the user interface 150 can present data associated with the communication platform, such as via a communication platform application 130. In various examples, the user interface 150 can be configured to present data associated with one or more communication channels, one or more direct messages and, in some examples, one or more workspaces. That is, in some examples, the user interface 150 can present messages sent via one or more communication channels and/or via direct message(s) in a single user interface so that the user (e.g., of the user computing device 104) can access and/or interact with data associated with the multiple channels and/or direct messaging instances that he or she is associated with and/or otherwise communicate with other users associated with the multiple channels and/or direct messaging instances. The communication channels and/or direct messaging instances can be internal to an organization of the user or externally shared (e.g., include users from two or more organizations, include a first user from a first organization and second user not associated with an organization).

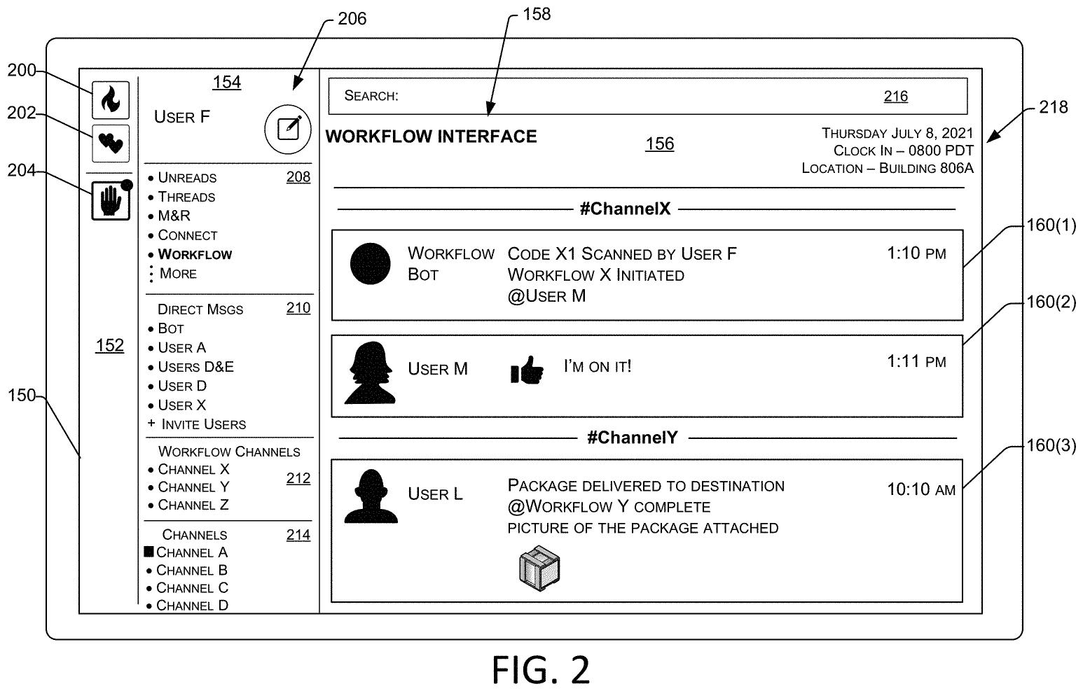

In some examples, the user interface 150 can include a first region 152, or pane, that includes indicator(s) (e.g., user interface element(s) or object(s)) associated with workspace(s) with which the user (e.g., account of the user) is associated. In some examples, the user interface 150 can include a second region 154, or pane, that includes indicator(s) (e.g., user interface element(s) or object(s)) representing data with which the user (e.g., account of the user) is associated. Additional details associated with the second region 154 and indicator(s) are described below with reference to FIG. 2.

In at least one example, the user interface 150 can include a third region 156, or pane, that can be associated with a data feed (or, “feed”) indicating messages posted to and/or actions taken with respect to one or more communication channels and/or other virtual spaces for facilitating communications (e.g., a virtual space associated with direct message communication(s), a virtual space associated with event(s) and/or action(s), etc.) as described herein. In at least one example, data associated with the third region 156 can be associated with the same or different workspaces. That is, in some examples, the third region 156 can present data associated with the same or different workspaces via an integrated feed. In some examples, the data can be organized and/or is sortable by workspace, time (e.g., when associated data is posted or an associated operation is otherwise performed), type of action, communication channel, user, or the like. In some examples, such data can be associated with an indication of which user (e.g., member of the communication channel) posted the message and/or performed an action. In examples where the third region 156 presents data associated with multiple workspaces, at least some data can be associated with an indication of which workspace the data is associated with. Additional details associated with the user interface 150, and the third region 156 operating as a messaging region or messaging interface, are described below with reference to FIG. 2.

In the illustrative example, the third region 156 includes a workflow interface 158 via which a user of the user computing device 104 can access one or more communication channels associated with workflows. In at least one example, the workflow interface 158 can provide a means by which a user can quickly access the one or more communication channels associated with workflows, such as to determine a status of the workflow(s). In the illustrative example, the workflow interface 158 includes data associated with a single channel (e.g., Channel X), in which a single message 160 is presented. However, this is not intended to be so limiting and the workflow interface 158 can include a greater or lesser number of communication channels associated with workflows and/or a greater or lesser number of messages transmitted therethrough.

In at least one example, the operating system 148 can manage the processor(s) 140, computer-readable media 142, hardware, software, etc. of the user computing device 104.

The communication interface(s) 144 can include one or more interfaces and hardware components for enabling communication with various other devices (e.g., the user computing device 104), such as over the network(s) 110 or directly. In some examples, the communication interface(s) 144 can facilitate communication via Websockets, APIs (e.g., using API calls), HTTPs, etc.

The user computing device 104 can further be equipped with various input/output devices 146 (e.g., I/O devices). Such I/O devices 146 can include a display, various user interface controls (e.g., buttons, joystick, keyboard, mouse, touch screen, etc.), cameras, audio speakers, microphones, connection ports, biometric recognition devices (e.g., fingerprint reader, eye scanners, facial recognition devices, etc.), and so forth.

While techniques described herein are described as being performed by the application(s) 130, techniques described herein can be performed by any other component, or combination of components, which can be associated with the server(s) 102, the user computing device 104, or a combination thereof.

FIG. 2 illustrates additional details associated with the user interface 150 that presents data associated with a workflow interface 158, as described above with reference to FIG. 1.

As described above, in at least one example, the user interface 150 can include a first region 152, or pane, that includes indicator(s) (e.g., user interface element(s) or object(s)) of workspace(s) with which the user (e.g., account of the user) is associated. As illustrated in FIG. 2, the user (e.g., User F) can be associated with three different workspaces. In some examples, the workspaces can be associated with a same organization (e.g., associated with a same organization identifier). In some examples, one or more of the workspaces can be associated with different organizations (e.g., associated with different organization identifiers). In some examples, one of the workspaces can be associated with users from a single organization (e.g., associated with a same organization identifier) and another of the workspaces can be associated with users from two or more different organizations (e.g., associated with different organization identifiers).

In at least one example, each workspace can be associated with a different indicator 200-204, presented via the first region 152. In some examples, a user account of the user (e.g., User F) can be associated with group identifiers that correspond to each of the workspaces (e.g., as determined by the communication platform user data 132). As such, the user account of the user can be associated with each of the workspaces. A first indicator 200 can represent a first workspace, a second indicator 202 can represent a second workspace, and a third indicator 204 can represent a third workspace. In some examples, at least one workspace can be associated with one or more workflows corresponding to a particular job position, title, and/or location. In some examples, responsive to receiving an indication that the user has checked in to a working location, such as by scanning a check-in work shift code associated with the working location, the communication platform can cause at least one indicator associated with the at least one workspace to be presented in the first region 152. In some examples, the at least one indicator can be presented the same or similarly as the other indicators (e.g., those not associated with workflows). In some examples, the at least one indicator can be presented differently from the other indicators. For example, as illustrated, the third indicator 204 can be associated with a workspace that corresponds to one or more job-related workflows. Responsive to receiving an indication that the user has checked into a working location associated with the job-related workflows, the communication platform can cause the third indicator 204 to be presented separately from the first indicator 200 and the second indicator 202. Though this is merely an illustrative example, and other differentiating presentations of the at least one indicator (e.g., third indicator) are contemplated herein, such as a different size, shape, color, animation associated therewith, or the like.

In some examples, the user can navigate between the workspaces by actuating a control associated with each of the indicators 200-204 without needing to log out of one workspace and log in to each of the other workspaces. Non-limiting examples of such indicators, or any indicators described herein, can include icons, symbols, links, tabs, or other user interface elements or objects. In some examples, such indicators can be associated with actuation mechanisms to enable a user to select an indicator and transition to another workspace. In some examples, a visual indicator can indicate which workspace a user is currently interacting with and/or most recently interacted with. For example, the third indicator 204 is outlined in a heavier weight than the first indicator 200 and the second indicator 202, thereby indicating which workspace the user is currently interacting with and/or most recently interacted with. In some examples, the indicators 200-204 can be associated with another indicator indicating that the corresponding workspace has been updated. An example is shown with respect to the third indicator 204.

While three indicators 200-204 are illustrated in FIG. 2, the user can be associated with any number of workspaces. In some examples, indicators associated with all of the workspaces with which a user is associated can be presented via the first region 152. In some examples, some of the indicators associated with all of the workspaces with which a user is associated can be presented via the first region 152 and the user can interact with the user interface 150 to view additional or alternative indicators. For example, as described above, the user can scan a check-in work shift code via the communication application 130. In response to receiving the indication of selection of the check-in work shift code, the communication platform can cause an indicator associated with a particular job-related workspace to be presented. In examples where fewer than all workspaces are represented via the user interface 150, the indicators can be arranged in alphabetical order, in an order of most recent interaction, in an order based on most frequent interaction, or some other order.

In some examples, the first region 152 may not be included in the user interface 150, and such information can be integrated into the user interface 150 via additional or alternative mechanisms.

In some examples, the user interface 150 can include a second region 154, or pane, that includes indicator(s) (e.g., user interface element(s) or object(s)) representing virtual space(s) associated with the workspace(s) with which the user (e.g., account of the user) is associated. In the illustrative example, the second region 154 can include a compose selectable option 206 that enables a user (e.g., User F) to compose a message to another user. For purposes of this discussion, a “message” can refer to any electronically generated digital object provided by a user using the user computing device 104 and that is configured for display within a communication channel and/or other virtual space for facilitating communications (e.g., a virtual space associated with direct message communication(s), etc.) as described herein. A message can include any text, image, video, audio, or combination thereof provided by a user (using a user computing device). For instance, the user can provide a message that includes text, as well as an image and a video, within the message as message contents. In such an example, the text, image, and video would comprise the message. Additionally or alternatively, as discussed above, the communication platform can generate and transmit messages via one or more communication channels responsive to receiving an indication of selection of a code associated with a workflow and/or step of the workflow. Each message sent or posted to a communication channel of the communication platform can include metadata comprising a sending user identifier, a message identifier, message contents, a group identifier, a communication channel identifier, or the like. In at least one example, each of the foregoing identifiers can comprise American Standard Code for Information Interchange (ASCII) text, a pointer, a memory address, or the like.

In at least one example, the second region 154 can include one or more sub-sections, or sub-panes, which can represent different virtual spaces. For example, a first sub-section 208 can include indicators representing virtual spaces that can aggregate data associated with a plurality of communication channels and/or workspaces. In at least one example, each virtual space can be associated with an indicator in the first sub-section 208. In some examples, an indicator can be associated with an actuation mechanism such that when actuated, can cause one of the one or more application(s) 130 (e.g., a communication platform application) to present data associated with the corresponding virtual space via the third region 156. In some examples, a virtual space can be associated with all unread data associated with each of the workspaces with which the user is associated. That is, in some examples, if the user requests to access the virtual space associated with “unreads,” all data that has not been read (e.g., viewed) by the user can be presented in the third region 156, for example in a feed. In such examples, different types of events and/or actions, which can be associated with different communication channels and/or virtual spaces, can be presented via a same feed. In some examples, such data can be organized and/or is sortable by workspace, time, type of action, communication channel, user, or the like. In some examples, such data can be associated with an indication of which user (e.g., member of the communication channel) posted the message and/or performed an action.

In some examples, each virtual space can be associated with a same type of event and/or action. For example, “threads” can be associated with messages, files, etc. posted in threads to messages posted in a communication channel and “mentions and reactions” (e.g., “M & R”) can be associated with messages or threads where the user (e.g., User F) has been mentioned (e.g., via a tag) or another user has reacted (e.g., via an emoji, reaction, or the like) to a message or thread posted by the user. That is, in some examples, same types of events and/or actions, which can be associated with different communication channels and/or virtual spaces, can be presented via a same feed. As with the “unreads” virtual space, data associated with such virtual spaces can be organized and/or is sortable by workspace, time, type of action, communication channel, user, or the like.

In at least one example, a virtual space can be associated with expediting communications between a user of an organization and other users associated with other organizations that are different from the organization of the user (illustrated as a select icon) and/or individual accounts, such as those associated with user accounts that do not have an associated organization. For example, “connect” can be associated with enabling expedited communications with users of other organizations. In some examples, the “connect” virtual space can be associated with one or more channels and/or direct messaging instances that include a user from at least one other organization. In such examples, responsive to receiving a selection of the “connect” indicator in the first sub-section 208, the communication platform can cause a presentation of the one or more channels and/or direct messaging instances in the third region 156.

In at least one example, a virtual space can be associated with workflow communications. In such an example, the workflow communications can include one or more communication channels and/or direct messaging instances that are associated with one or more workflows. For example, in response to receiving an indication of selection of a check-in work shift code, the communication platform can cause a presentation of a “workflow” indicator associated with the workflows corresponding to the check-in work shift code. In some examples, “workflow” virtual space can be associated with one or more channels and/or direct messaging instances that are associated with a particular job, work shift, and/or location related workflow. In such examples, responsive to receiving a selection of the “workflow” indicator in the first sub-section 208, the communication platform can cause a presentation of data associated with the one or more channels and/or direct messaging instances in the third region 156.

In at least one example, the second region 154 of the user interface 150 can include a second sub-section 210, or sub-pane, that includes include indicators representative of communications with individual users or multiple specified users (e.g., instead of all, or a subset of, members of an organization). Such communications can be referred to as “direct messages.” That is, the second sub-section 210, or sub-pane, can include indicators representative of virtual spaces that are associated with private messages between one or more users (e.g., direct messaging instances).

In addition to the second sub-section 210, the second region 154 can include a third sub-section 212, or sub-pane, that includes indicators representing workflow communication channels. The workflow communication channels can include communication channels that are associated with a particular job, work shift, and/or location. In some examples, the workflow communication channels can include public channels, private channels, shared channels (e.g., between groups or organizations), single workspace channels, cross-workspace channels, combinations of the foregoing, or the like. In some examples, the workflow communication channels represented can be associated with a single workspace. In some examples, the workflow communication channels represented can be associated with different workspaces (e.g., cross-workspace). In at least one example, if a workflow communication channel is cross-workspace (e.g., associated with different workspaces), the user can be associated with both workspaces, or can only be associated with one of the workspaces. In some examples, the workflow communication channels represented can be associated with combinations of communication channels associated with a single workspace and communication channels associated with different workspaces.

In some examples, the second region 154 can also include a fourth sub-section 214, or sub-pane, that includes indicators representing other communication channels (e.g., non-workflow related channels, non-location or job-related channels, etc.). As discussed above with regard to the workflow communication channels, the other communication channels can include public channels, private channels, shared channels, single workspace channels, cross-workspace channels, combinations of the foregoing, or the like. In some examples, the communication channels represented can be associated with a single workspace. In some examples, the communication channels represented can be associated with different workspaces (e.g., cross-workspace). In at least one example, if a communication channel is cross-workspace (e.g., associated with different workspaces), the user can be associated with both workspaces, or can only be associated with one of the workspaces. In some examples, the communication channels represented can be associated with combinations of communication channels associated with a single workspace and communication channels associated with different workspaces.

In some examples, the fourth sub-section 214 can depict all the other communication channels (e.g., non-workflow, job, or location related channels), or a subset of all the other communication channels, that the user has permission to access (e.g., as determined by the permission data stored in association with communication platform user data 132). In such examples, the communication channels can be arranged alphabetically, based on most recent interaction, based on frequency of interactions, based on communication channel type (e.g., public, private, shared, cross-workspace, etc.), based on workspace, in user-designated sections, or the like. In some examples, the fourth sub-section 214 can depict all communication channels, or a subset of all communication channels, that the user is a member of, and the user can interact with via the user interface 150 to browse or view other communication channels that the user is not a member of but are not currently displayed in the fourth sub-section 214. In some examples, the third sub-section 212 and the fourth sub-section 214 can be combined such that the workflow communication channels, and the other communication channels are presented in a single sub-section. In such examples, the workflow communication channels can include a differentiating indicator to indicate that the communication channels are workflow related.

In some examples, different types of communication channels (e.g., public, private, shared, cross-workspace, etc.) can be in different sections of the fourth sub-section 214, or can have their own sub-regions or sub-panes in the user interface 150. For example, as described above, workflow communication channels can be presented in association with the “workflow” indicator illustrated in the first sub-section 208. In some examples, communication channels associated with different workspaces can be in different sections of the fourth sub-section 214, or can have their own regions or panes in the user interface 150. For example, workflow communication channels associated with a workflow workspace (e.g., third indicator 204) can be presented in a separate sub-section, such as the third sub-section 212.

In some examples, the indicators can be associated with graphical elements that visually differentiate types of communication channels. For example, Channel A is associated with a square visual element instead of a circle visual element. As a non-limiting example, and for the purpose of this discussion, the square visual element can indicate that the user is not a current member of Channel A, whereas the circle visual element can indicate that the user is a current member of Channel B. In some examples, additional or alternative graphical elements can be used to differentiate between public communication channels, private communication channels, shared communication channels, communication channels associated with different workspaces, workflow communication channels, and the like. In other examples, communication channels that the user is not a current member of may not be displayed in the fourth sub-section 214 of the user interface 150. In such examples, the user can navigate to a different interface (not shown) to browse additional channels that are accessible to the user but to which the user is not currently a member. Additionally or alternatively, the user can search for additional channels utilizing a search mechanism 216. In some examples, the search mechanism 216 can enable a search for communication channels, particular messages, data transmitted via and/or stored in association with the communication platform, and the like. In some examples, the search can be performed across each workspace with which the user is associated, or the search can be restricted to a particular workspace, based on a user specification.

As described above, in at least one example, the user interface 150 can include a third region 156, or pane, for presenting data associated with the communication platform, such as data associated with one or more communication channels, direct messaging instances, workspaces, and/or one or more external connections. In at least one example, the third region 156 can present data that is associated with a feed indicating messages posted to and/or actions taken with respect to a communication channel and/or other virtual space (e.g., a virtual space associated with direct message communication(s), a virtual space associated with event(s) and/or action(s), etc.) for facilitating communications. As described above, in at least one example, data associated with the third region 156 can be associated with a workflow interface 158. That is, in some examples, the third region 156 can present data associated with one or more communication channels and/or direct messaging instances that are associated with one or more workflows corresponding to a code, location, job, work shift, or the like.

For example, in FIG. 2, the user can interact with the user interface 150 to view data associated with the workflow interface 158. In some examples, the workflow interface 158 can provide a means by which the user can access data associated with a status of one or more workflows. In some examples, the workflow interface 158 can provide a means by which the user can compose a message via a workflow communication channel and/or direct messaging instance to one or more other users that are associated with the workflow. For example, the user can post a message asking about the status of a particular workflow in a channel associated therewith. For another example, the user can view a first message 160(1) in Channel X indicating that a step in an associated workflow is complete and can respond by transmitting a second message 160(2) indicating that the user will complete the next step in the workflow. For yet another example, the workflow interface 158 can enable the user to monitor the status of a workflow, such as to determine a workflow associated with Channel Y is complete. The user can additionally access additional information associated with a step in a workflow by viewing the messages posted in a channel associated therewith. For example, a third message 160(3) includes an indication that a final step associated with a packaging and delivery workflow is complete (e.g., package delivered). The third message 160(3) includes additional information of an image of the package at the delivery location, such as to provide additional documentation of package delivery and condition and/or security of the package at the delivery location.

In FIG. 2, the workflow interface 158 includes shift-related data 218. The shift-related data 218 can include information associated with a work shift of the user. In the illustrative example, the shift-related data 218 includes a current date, a check-in time (illustrated as “clock in”), and a location associated with the work shift. However, this is not intended to be so limiting and he shift-related data 218 can include additional or alternative information, such as a current time, supervisor information (e.g., on-shift supervisor), a link to communicate with an on-shift supervisor, management information, organization information, position title, and/or the like.

In various examples, additional or alternative data can be presented via the third region 156 of the user interface 150. For example, non-limiting examples of additional data that can be presented via the third region 156 include a feed associated with one or more communication channels and/or one or more direct messaging instances, members added to and/or removed from the communication channel, file(s) (e.g., file attachment(s)) uploaded and/or removed from the communication channel, application(s) added to and/or removed from the communication channel, post(s) (data that can be edited collaboratively, in near real-time by one or members of a communication channel) added to and/or removed from the communication channel, description added to, modified, and/or removed from the communication channel, modifications of properties of the communication channel, etc.

In at least one example, data associated with a communication channel can be viewable to at least some of the users of a group of users associated with a same group identifier. In some examples, for members of a communication channel, the content of the communication channel (e.g., messaging communications) can be displayed to each member of the communication channel. For instance, a common set of group-based messaging communications can be displayed to each member of the communication channel such that the content of the communication channel (e.g., messaging communications) may not vary per member of the communication channel. In some examples, data associated with a communication channel can appear differently for different users (e.g., based on personal configurations, group membership, etc.). In at least one example, the format of the individual communication channels or virtual spaces can appear differently to different users, such as based on organizations associated therewith. For example, a format of an individual communication can include one or more indicators of one or more organizations with whom users of the individual communication channel is associated. In some examples, the format of the individual communication channels or virtual spaces can appear differently based on which workspace a user is currently interacting with or most recently interacted with. In some examples, the format of the individual communication channels or virtual spaces can appear differently for different users (e.g., based on personal configurations, group membership, etc.).

The user interface 150 is a non-limiting example of a user interface that can be presented via the user computing device 104 (e.g., by one of the one or more applications 130). In some examples, the application 130 can receive data from the messaging component 120, the scan component 122, and/or a third-party computing device(s) 106 (e.g., third-party application 136, third-party document 134, etc.), and can generate and present the user interface 150 based on the data. For example, as discussed above, the communication platform can receive indications of selection of one or more codes associated with a workflow and can generate messages associated with the codes. The communication platform can send the data associated with the messages to the application 130, causing the data to be presented in a channel associated with the workflow.

The communication platform can additionally send data associated with the indications of selection to a third-party service provider 108 with an instruction to update one or more third-party documents 134 associated with the indications of selection. The instruction can additionally include an instruction to send the updates to the application 130, for presentation of an updated third-party document 134. The third-party document 134 can provide a consolidated source of documentation of the status of the workflow (e.g., completion of various stages of the workflow complete. In various examples, the communication platform and/or the third-party service provider 108 can cause the updated third-party document 134 to be presented via the channel on the user interface 150, such as in the third region 156. In some examples, an indicator associated with the third-party document 134 can be presented via the channel. In such examples, the user can access the third-party document 134 by selecting the indicator.

In some examples, the application 130 can receive the data and instructions for generating the user interface 150 from the messaging component 120 and/or scan component 122. In such an example, the application 130 can present the user interface 150 based on the instructions. Additional or alternative data can be presented via a user interface and additional or alternative configurations can be imagined.

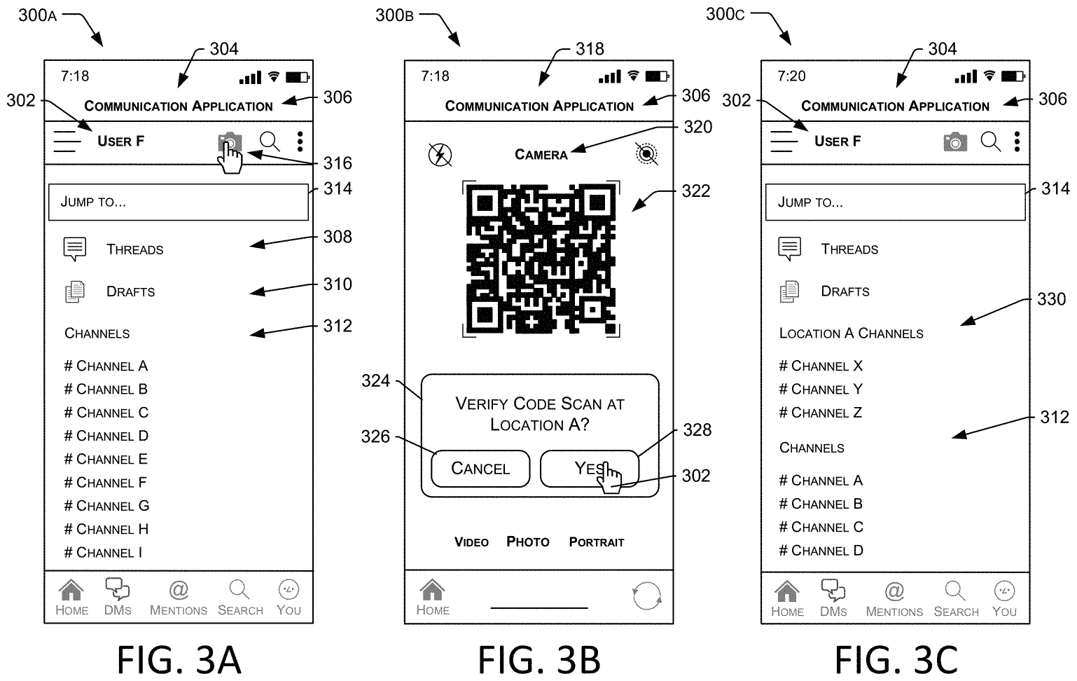

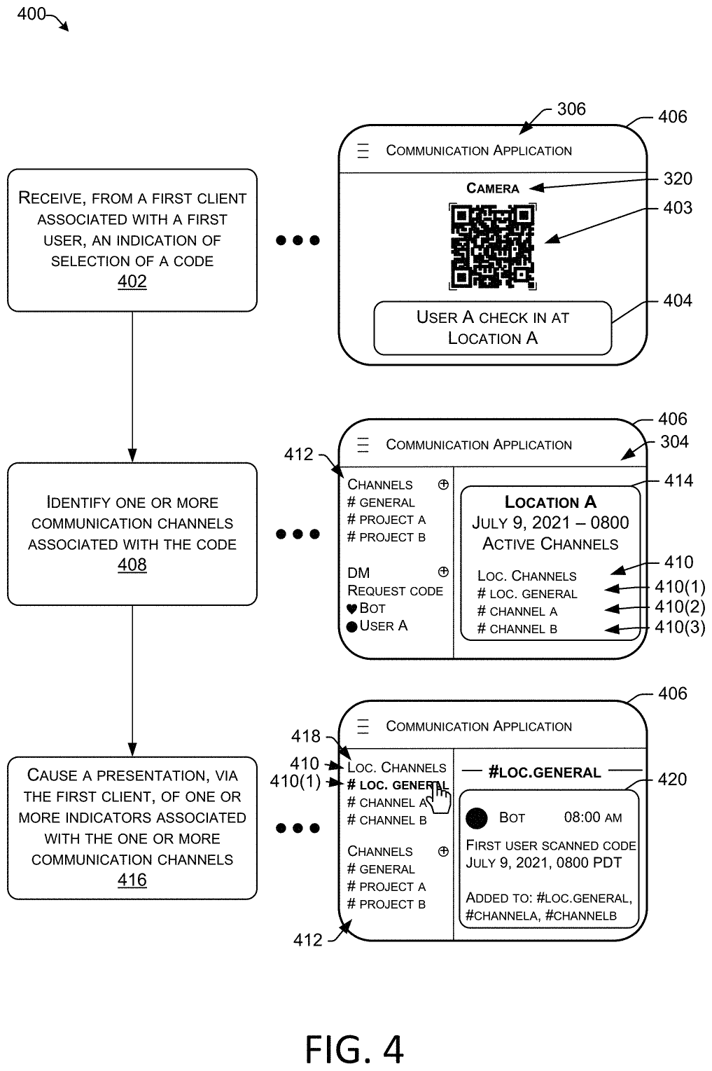

FIG. 3A-FIG. 3C illustrate example user interfaces corresponding to a user 302 checking in at a location and being granted access to particular communication channels associated with the location. The interfaces can be generated by a computing device of a communication platform (e.g., server(s) 102) and transmitted to one or more user computing devices (e.g., user computing device(s) 104) for presentation. Additionally or alternatively, the interfaces can be generated by the user computing device(s) based at least in part on instructions received from the communication platform. The interfaces illustrated in FIGS. 3A-4C can, but need not, be implemented in the context of the system 100.

In at least one example, the interfaces 300A, 300B, and/or 300C can be associated with a user computing device, such as user computing device 104.

Interface 300A shown in FIG. 3A illustrates a home page 304 associated with a communication application 306, such as application 130. In the illustrative example, the home page 304 includes a thread indicator 308, a drafts indicator 310, and a list of channels 312. The thread indicator 308 can include a selectable control that enables the user 302 to access one or more threads associated with communication channels of which the user 302 is a member. The drafts indicator 310 can include a selectable control that enables the user 302 to access one or more pending drafts of messages that the user 302 has initiated. The list of channels 312 can include indicators associated with all communication channels, or a subset of all communication channels, that the user 302 is a member of, and the user can interact with via the user interface 300A to browse or view other communication channels that the user is not a member of but are not currently displayed in the user interface 300A.

In various examples, the home page 304 can include a search mechanism 314, such as search mechanism 216, that can enable a search for communication channels, particular messages, data transmitted via and/or stored in association with the communication platform, and the like. In some examples, the search can be performed across each workspace with which the user is associated, or the search can be restricted to a particular workspace, based on a user specification.

In some examples, the home page 304 can include a camera icon 316 that enables access of a camera via the communication application 306. Though illustrated as a camera icon associated with a camera, this is not intended to be so limiting, and other I/O devices are contemplated herein. For example, the home page 304 can include a microphone icon that enables access to a microphone for inputting a code or other data.

Interface 300B shown in FIG. 3B illustrates a camera page 318 associated with the communication application. In various examples, the communication application can be granted access to a camera 320 associated with a user computing device. In such examples, when granted access to the camera 320, the communication application can cause the camera page 318 to be presented via the user computing device. In some examples, the camera page 318 can be a native device camera application configured to transmit data to the communication application, such as via an API. In some examples, in response to receiving the indication of selection of a code associated with the communication platform, the native device camera application can cause the communication application to be launched on the user computing device.

In some examples, the camera page 318 can be presented on the interface 300B in response to receiving an indication of selection of a camera icon 316, such as that illustrated in interface 300A. In some examples, the camera page 318 can be presented in response to a user manipulating the associated user computing device to scan a code 322. In such examples, in response to the camera 320 detecting the code 322, the communication application 306 can automatically launch the camera page 318.

In the illustrative example, the code 322 includes a QR code. Though this is not intended to be so limiting and the code 322 can include a bar code, list of numbers, symbols, letters, or the like that is configured to be processed (e.g., read) by a machine or a person, such as user 302. For example, the code can include a string of numbers that can be verbally input into the communication application 306, such as via a microphone.

In some examples, the code 322 can include a code associated with a step in a workflow, such as to document processing or completion of the step via a communication channel. In some examples, the code 322 can include a work shift code associated with the user 302 checking in or checking out (e.g., clock in, clock out, etc.) to a work location, a particular position, a particular job type, or the like. For example, the code 322 can be associated with the user 302 checking in to work at a particular work location (e.g., Location A). The particular work location can be associated with one or more workflows and/or communication channels associated therewith. For another example, the code 322 can be associated with the user 302 completing a step associated with one or more workflows corresponding to the location (e.g., Location A).

In various examples, responsive to receiving an indication of selection of the code 322 (e.g., the user 302 placing the camera 320 in view of the code 322), the communication platform can cause a verification window 324 to be presented on the camera page 318. The verification window 324 can provide the user 302 a means by which the user 302 can verify that the scanned code 322 is the intended code. In response to receiving an indication of selection of a cancel selectable control 326, the communication platform can determine that the code 322 is not verified and will cease processing information associated therewith. For example, in response to receiving an indication of selection of the cancel selectable control 326, the communication platform can determine that the user 302 does not intend to check in or complete a task at Location A. In response to receiving an indication of selection of an accept selectable control 328, the communication platform can determine that the code 322 is verified. For example, in response to receiving an indication of selection of the accept selectable control 328, the communication platform can determine that the user 302 intends to check in or complete a task at Location A.

Interface 300C shown in FIG. 3C illustrates the home page 304 associated with the communication application 306 after the user 302 has scanned the code 322 associated with the location (e.g., Location A), such as that illustrated in FIG. 3B. In various examples, in response to receiving an indication of selection of the code 322 (e.g., data associated with the code 322), the communication platform can identify one or more virtual spaces associated with the code 322. In the illustrative example, the communication platform identifies three communication channels 330 (Channel X, Channel Y, and Channel Z) that are associated with the code 322, though a greater or lesser number of virtual spaces can be associated with a code 322. In some examples, the communication platform can identify that the code 322 is associated with a first step in one or more workflows and can generate the communication channels 330 to be associated therewith. In some examples, the communication platform may open or create and open the corresponding channel that the code 322 is associated with upon launching the communication platform. In some examples, the corresponding communication channels 330 are bolded to indicate that there is an update in the communication channel.

In various examples, in response to receiving the indication of selection of the code 322, the communication platform can grant the user 302 access to the communication channels 330 associated with the code 322 (e.g., associate the user 302 with the communication channels 330). In some examples, in response to receiving an indication of selection of the code 322, the communication platform can generate and transmit a notification that the code 322 has been scanned. The notification can include a message transmitted via one or more channels 330 and/or a pop-up notification. For example, the notification can include a pop-up notification that indicates that the user 302 checked in to Location A. For another example, the notification can include a message indicating that the user 302 has completed a task associated with a workflow.

In some examples, the communication platform can cause a presentation of the communication channels 330, such as in a list of the home page 304. In the illustrative example, the communication channels 330 can be presented as a separate sub-section from the list of channels 312. In other examples, the communication channels 330 can be presented in a same sub-section of the home page 304 as the list of channels 312. In some examples, the communication channels 330 can include an indicator, such as to distinguish the communication channels 330 from the list of channels 312.

FIGS. 4-10 illustrate example processes in accordance with embodiments of the disclosure. These processes are illustrated as logical flow graphs, each operation of which represents a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be combined in any order and/or in parallel to implement the processes.

FIG. 4 illustrates an example process 400 for enabling access to a communication channel based on a location. In some instances, some or all of process 400 can be performed by one or more components in the system 100. By way of example and not limitation, the communication platform referred to in process 400 can be representative of a computing device associated with the (communication platform) server(s) 102, a client referred to in process 400 can be representative of the user computing device(s) 104 and/or application 130. However, the process 400 is not limited to being performed by the system 100.

At operation 402, the communication platform receives, from a first client associated with a first user, an indication of selection of a code 403, such as code 322. In some examples, the indication of selection of the code 403 can include an indication that the first user input the code 403, such as via an input/output device associated with the first client. In the illustrative example, the first user inputs the code 403 by scanning the code 403 with a camera 320 associated with the first client. In other examples, the first user can input the code 403 by typing the code 403 into a keyboard, verbally inputting the code 403, or the like.

In various examples, in response to the indication of selection of the code 403, the communication platform can identify that the code 403 corresponds to a check-in work shift code associated with Location A. Though illustrated as the code 403 being associated with a location, this is not intended to be so limiting, and the code 403 can be associated with a particular job, work shift, position, title, and/or the like. Additionally, the communication platform can identify the first user and/or a user account associated therewith, from which the indication of selection of the code 403 was received. For example, a retail employee can access a user account associated therewith on a computing device that is shared among two or more employees. The retail employee can then scan the code 403 utilizing the computing device and the communication platform can determine that the retail employee is associated with the scan of the code 403 and is currently operating the computing device.

In some examples, the communication platform can be configured to determine that the computing device is a common device that is (or can be) associated with two or more user accounts of the communication platform. In some examples, in response to receiving an indication of selection of the code 403, the communication platform can identify a particular user associated with the code 403 and can cause a user account associated with the particular user to be logged in to an instance of the communication application. That is, the communication platform can receive a code 403 and can cause an automatic log-in of a particular user account associated with the code 403. In some examples, the communication platform can automatically log the user in to the instance of the communication application in response to receiving a verification of authenticity of the user, such as from a third-party authenticator application or other authentication system configured to authenticate a user. In such examples, the communication platform can send a request to a verification system to authenticate the user, such as via a separate computing device (e.g., user's mobile phone), and in response to receiving an indication of authentication from the authentication system, can automatically log the user in to the instance of the communication application.

Similarly, in response to receiving a second code 403, such as that associated with a check-out work shift code (e.g., clocking out of a shift), the communication platform can cause the particular user account to be logged off the computing device. Continuing the example from above, a single computing device can be used by two or more retail employees in a retail environment. A first employee can operate the device with a first user account of the communication platform active during a first shift. The first employee can scan a first code to clock out of the first shift. In response to receiving an indication of the scan of the first code, the communication platform can automatically (e.g., without further input from the first user) log the first user account out of the communication application. A second employee can take possession of the computing device and scan a second code to clock into a second shift. In response to receiving an indication of the scan of the second code, the communication platform can automatically log the second user account in to the communication application.

Additionally, in some examples, the communication platform can be configured to enable two or more instances of the communication application to be active (e.g., launched) on a computing device at one time. In such examples, two or more employees can easily shift between user accounts by scanning respective codes. For example, the first employee and the second employee can be on a same shift and/or overlapping shifts. The communication application can include a first instance of an application associated with the first employee (e.g., the first employee is logged into the first instance of the application) and a second instance of the application associated with the second employee. In response to receiving an indication of selection of a first code associated with the first employee, the communication platform can cause the first instance of the application to be activated, launched, or otherwise presented on the computing device. The communication platform can then store data associated with interactions of the first employee in association with the first user account (and not the second user account). In various examples, the communication platform can be configured to securely cache data and/or state information associated with multiple users on a single computing device. In some examples, the data and/or state information can be stored locally on a datastore of the computing device and/or remotely on a datastore associated with a server, such as datastore 126 associated with server(s) 102. The communication platform can store data in association with a particular user account based on an indication of the particular user account being logged in to and/or currently active on the computing device.

Additionally or alternatively, the communication platform can be configured to automatically log a user into a terminal (e.g., computing device) based on a determination that the user is located proximate the terminal and has an instance of the communication application active on a user computing device. In some examples, the automatic logon can be based on a determination that the terminal and a user account of the user that is currently logged into the instance of application are associated a same organization. In some examples, the automatic logon can be determined based on a determination that the user account is associated with a current work shift (e.g., that the user is currently working at the organization). In such examples, the communication platform can access organization or user data stored in a datastore, such as datastore 126, to determine whether the user account is associated with the current work shift. In some examples, the communication platform can determine, based on location data associated with the user computing device and/or the terminal, that the user computing device including the active instance of the communication application is within a threshold distance (e.g., 1 foot, 1 meter, 10 inches, etc.) of the terminal. In such examples, the communication platform can automatically log the user account into the terminal based on a determination that the user computing device is within the threshold distance.

In various examples, in response to the identification that the code 403 corresponds to the check-in work shift code and/or an identification of the first user, the communication platform can cause a first notification 404 to be presented on an interface 406 associated with a communication application 306 (e.g., application 130). The notification can provide a summary of data associated with the code 403. For example, the first notification 404 includes an indication that the first user (e.g., User A) checked in at Location A.

In various examples, the communication platform can request an authentication of the first user in association with the indication of selection of the code. In such examples, the communication platform can cause a request to provide the authentication to be presented via the first client. The authentication can include a password, biometric data, or other data used for authenticating a user. For example, the communication platform can request an input of a fingerprint, to verify the authenticity of the first user. In various examples, the first user may input the fingerprint via an input/output device associated with the first client. The communication platform can receive the input and determine whether the authenticity of the first user is verified. Based on a determination that the authenticity is not verified, the communication platform can cause an error message to be presented via the first client. Based on a determination that the authenticity is verified, the communication platform can perform additional steps associated with the process 400.

At operation 408, the communication platform identifies one or more communication channels 410 (e.g., communication channels 330) associated with the code 403. In some examples, the communication channel(s) 410 can include communication channels that are associated with the location (e.g., Location A), and/or a particular job, work shift, position, title, and/or the like. Additionally, the communication channel(s) can be identified based on a user identifier associated with the first user. In such examples, the communication platform can identify the communication channel(s) associated with the code and those that are associated with the first user.

The communication channel(s) 410 can include active communication channels associated with the code 403. In the illustrative example, the code 403 has associated therewith three communication channels 410, a first communication channel 410(1), a second communication channel 410(2), and a third communication channel 410(3). However, this is not intended to be so limiting and greater or lesser numbers of communication channels 410 can be associated with a code 403.

Additionally, although not illustrated in FIG. 4, the code 403 can be associated with one or more direct messaging instances between the user and one or more other users. For example, the user can generate a direct messaging instance with a manager that is associated with the code 403 and/or the location. The direct messaging instance can enable private communications between the user and the manager during work hours, such as when the user has checked-in to Location A. In various examples, the communication platform can cause a presentation thereof via the interface 406 in response to receiving the indication of selection of the code 403.

In the illustrative example, the first communication channel 410(1) includes a general communication channel associated with the location. The general communication channel can enable data to be shared between two or more users associated with the location. In some examples, the communication channels 410 can include one or more communication channels that are associated with workflows, as described above. For example, the second communication channel 410(2) is associated with a first workflow (e.g., workflow A) and the third communication channel 410(3) is associated with a second workflow (e.g., workflow B). In various examples, the second communication channel 410(2) and the third communication channel 410(3) can enable the user to access data associated with respective workflows.

In some examples, in response to identifying the communication channel(s) 410, the communication platform causes a home page 304 to be presented via the interface 406. As discussed above, the home page 304 can include a first set of indicators 412 corresponding to virtual spaces that are not associated with the code 403 and/or can be continually accessible to the user via the communication application 306. The home page 304 can include a notification 414 associated with the communication channel(s) 410. In the illustrative example, the notification 414 can include information associated with the input of the data associated with the code 403 (e.g., scan of the code 403), such as the location, date, and time. In some examples, the notification 414 can include a list of the channels 410 and/or a status indicator associated with the channels 410. Though illustrated as including active channels, the notification 414 can additionally include, in some examples, inactive channels, such as those associated with completed workflows. In such examples, the user can access inactive channels to review data associated with a previously completed workflow.

At operation 416, the communication platform causes a presentation, via the first client, of one or more indicators 418 associated with the one or more communication channels 410. In various examples, the communication platform can modify permissions for the user to access (e.g., enable access) to the one or more communication channels 410 based on the indication of selection of the code 403. In such examples, the communication platform can cause the presentation of the indicators 418 in response to the user being granted access to the communication channel(s) 410.

In various examples, in response to receiving an indication of selection of a channel of the one or more communication channels 410, the communication platform can cause data associated therewith to be presented via the interface 406. In the illustrative example, the data includes a message 420 transmitted via the selected channel (e.g., first communication channel 410(1)). The message 420 can include a message generated by a member of the selected channel and/or a message generated by the communication platform (illustrated as “Bot”). In some examples, the communication platform can generate messages in response to receiving an indication of selection of a code, such as code 403. For example, the communication channel can receive an indication of selection of the code 403 and can determine that the first user checked in to Location A. The communication channel can generate a message 420 to transmit via the first communication channel 410(1) that corresponds to general information about Location A, the message 420 indicating information about the check in by the first user. In such an example, other users may be able to identify who is checked in at Location A, and details about their check in. The data associated with check-ins and corresponding check-outs can be stored in association with the first communication channel 410(1) and utilized by management, payroll, and the like of an organization. For example, the communication platform may be configured to send check-in and check-out times to payroll and/or management, such as to track working hours of employees.

In various examples, the communication platform can determine that the first user (e.g., a user account thereof) was previously associated with the communication channel(s), and that a user setting with respect to the communication channel(s) was set in a “do not disturb” setting (e.g., mode) or other setting in which the first user did not receive updates or notifications associated with the communication channel(s). In such examples, the communication platform can modify the settings associated with the communication channel(s) to enable the first user to receive updates and/or notifications associated with the communication channel(s). For example, the communication channel can receive an indication that a user checks-in on a shift, such as based on receiving the indication of selection of the code. The communication channel can identify the communication channel(s) and can modify a setting associated with the user account and the communication channel(s) from a do not disturb setting to an “on-shift” setting to enable the user to receive notifications and/or updates associated with the communication channel(s).

In various examples, the communication platform can be configured to receive an indication of selection of another code associated with the user checking out of a work shift. In some examples, based on receiving the indication of selection of the other code, the communication platform can mute or otherwise disable the one or more communication channels associated with the (original) code, such as those identified at operation 408.

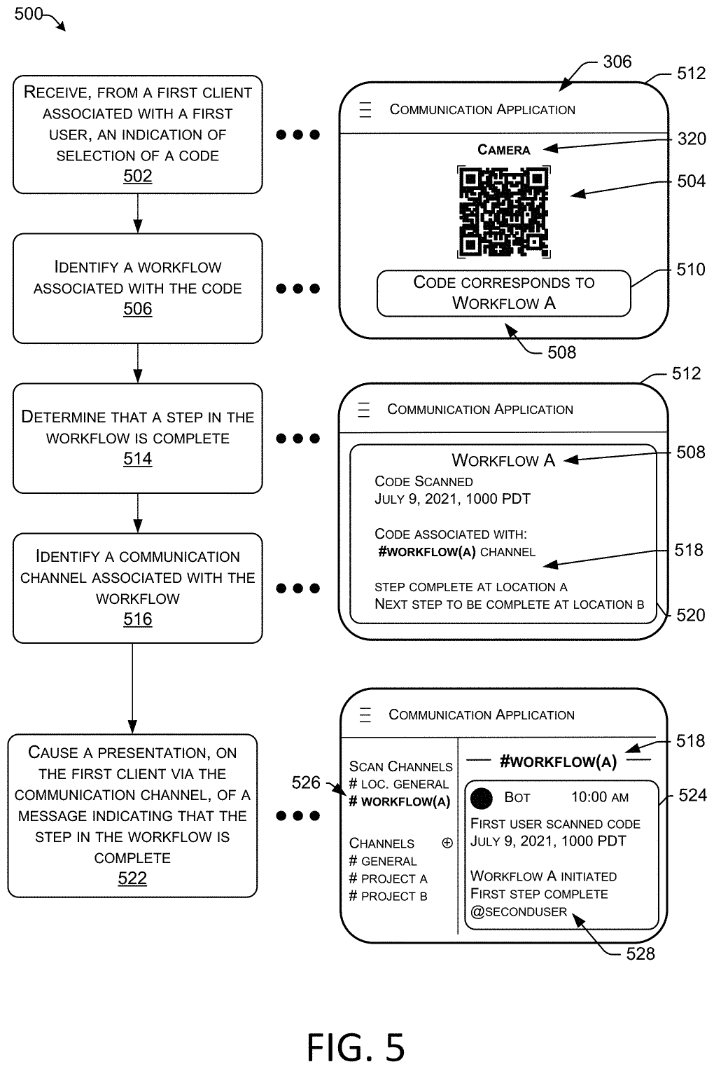

FIG. 5 illustrates an example process 500 for enabling access to a communication channel based on a location. In some instances, some or all of process 500 can be performed by one or more components in the system 100. By way of example and not limitation, the communication platform referred to in process 500 can be representative of a computing device associated with the (communication platform) server(s) 102, a client referred to in process 500 can be representative of the user computing device(s) 104 and/or application 130. However, the process 500 is not limited to being performed by the system 100.

At operation 502, the communication platform receives, from a first client associated with a first user, an indication of selection of a code 504, such as code 322, code 403, and the like. In some examples, the indication of selection of the code 504 can include an indication that the first user input the code 504, such as via an input/output device associated with the first client. In the illustrative example, the first user inputs the code 504 by scanning the code 504 with a camera 320 associated with the first client. In other examples, the first user can input the code 504 by typing the code 504 into a keyboard, verbally inputting the code 504, or the like.

At operation 506, the communication platform identifies a workflow 508 (e.g., Workflow A) associated with the code 504. As discussed above, the workflow 508 can include a sequence of processes (e.g., steps) through which a piece of work passes from initiation to completion. In various examples, in response to identifying the workflow 508, the communication platform can cause a notification 510 to be presented via an interface 512 associated with the client.

At operation 514, the communication platform determines that a step in the workflow 508 is complete. In various examples, the communication platform determines that the step in the workflow 508 is complete based on data and/or characteristics associated with the code 504. In such examples, the communication platform receives the indication of selection of the code 504 including the data associated therewith and can identify characteristics associated with the code 504, such as those stored in a datastore 126 in association with one or more codes.

At operation 516, the communication platform identifies a communication channel 518 associated with the workflow. As discussed above, the communication channel 518 can include a means by which data associated with the workflow 508 can be documented. For example, the communication channel 518 can include one or more messages that indicate completion of various steps of the workflow 508 and/or data associated therewith.

In some examples, the communication platform can identify that the step in the workflow 508 is an initial step (e.g., first step). In some examples, the communication platform can determine, based in part on the step being the initial step, that the communication channel 518 associated with the workflow 508 has not been generated. In such examples, the communication platform can generate the communication channel 518 based in part on the code 504 and/or the completion of the initial step. In various examples, the communication platform can generate the communication channel 518 without further input from a user. In some examples, the communication platform can identify one or more users to associate with the communication channel 518, such as based on users who are checked in at a particular location (e.g., checked in on shift for a particular job), users associated with a workspace corresponding to the workflow, and/or the like.

In some examples, the communication platform can cause a presentation, via the interface 512, of data 520 corresponding to the indication of selection of the code 504 and/or the communication channel 518 associated therewith. The data 520 can include a date and/or time associated with the input of the code 504, the identified communication channel 518 associated with the code 504, a step associated with the code 504, a next step in the workflow 508, an indication of a user associated with the next step, a time and/or date (e.g., timestamp) associated with an initiation of the workflow 508, a timestamp associated with generation of the communication channel 518, and/or the like. In some examples, some or all of the data 520 can be presented in a message transmitted via the communication channel 518.

At operation 522, the communication platform causes a presentation, on the first client via the communication channel, of a message 524 indicating that the step in the workflow is complete. In various examples, responsive to receiving an indication of selection of an indicator associated with a workflow interface (as described above) or an indicator 526 associated with the communication channel, the communication platform can cause the communication channel 518 including the message 524 to be presented via the interface 512.

In various examples, the message 524 provides at least a portion of the data 520 associated with the code 504. In the illustrative example, the message 524 includes a timestamp associated with the indication of selection of the code 504 (e.g., time the code 504 was scanned), a workflow 508 associated with the code 504, a step completed in association with the indication of selection of the code 504, and an @mention 528 of another user associated with the workflow 508. Though this is not intended to be so limiting, and the message 524 generated by the communication platform can include more or less data 520 associated with the code 504.

In various examples, the communication platform can be configured to identify a next step in the workflow 508 to be completed. The next step can include a step after the step that is determined to be complete at operation 514. In various examples, the communication platform can identify one or more users associated with the next step in the workflow 508 and can include the @mention 528 of the user(s) (or other means of tagging the user(s)) in the message 524. In such examples, the communication platform can provide an indication to the user(s) that the step is complete, and that the user(s) can perform the next step associated with the workflow 508.

In various examples, the communication platform can be configured to determine that the next step in the workflow 508 is to be performed by a robot. In some examples, the communication platform can send an instruction to the robot to complete the next step in the workflow 508. That is, the communication platform can cause the robot to perform the next step. In various examples, the communication platform can monitor the progress of the robot, and can document the progress in one or more messages associated with the communication channel. For example, in a shipping warehouse, a first step of packaging an item can be performed by a human and a second step of delivering the item to a location for delivery can be performed by a robot. The communication platform can determine that the first step is complete based on receiving data associated with a first code. The communication platform identifies the robot to perform the next step and causes the robot to complete the next step. Responsive to receiving an indication of selection of a second code from the robot, the communication platform can determine that the next step is complete. The communication platform can cause a message associated with completion of the next step to be presented via the communication channel accessible to members of the communication channel.

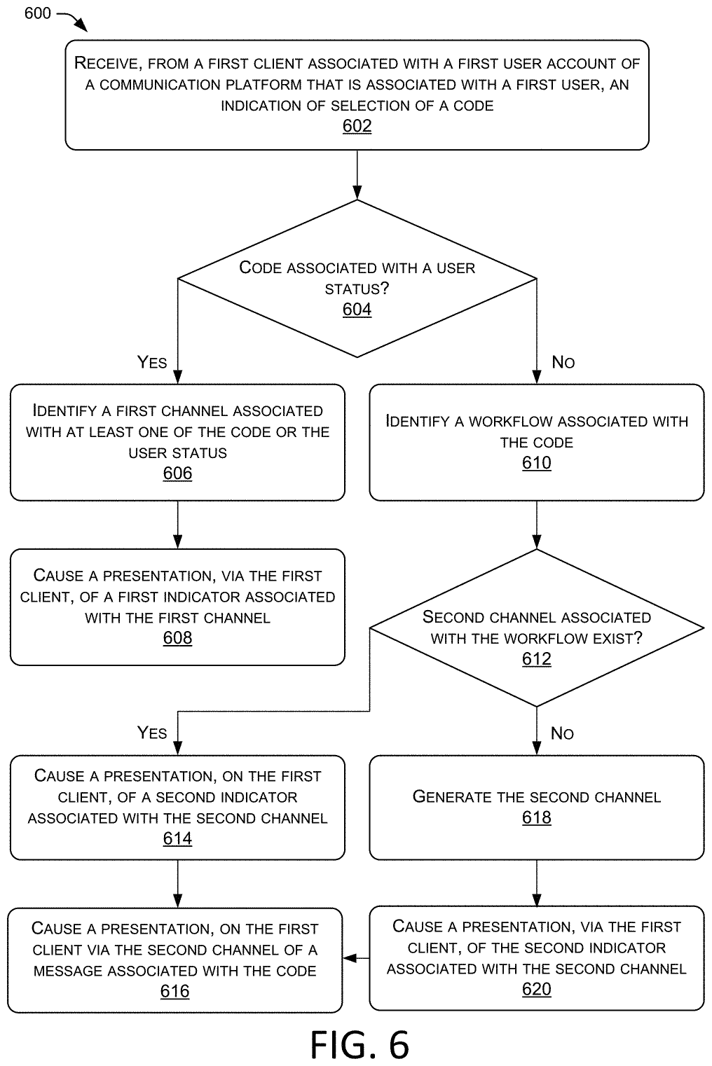

FIG. 6 illustrates an example process 600 for updating a user interface of a communication application based on an indication of selection of a code. In some instances, some or all of process 600 can be performed by one or more components in the system 100. By way of example and not limitation, the communication platform referred to in process 600 can be representative of a computing device associated with the (communication platform) server(s) 102, a client referred to in process 600 can be representative of the user computing device(s) 104 and/or application 130. However, the process 600 is not limited to being performed by the system 100.

At operation 602, the communication platform receives, from a first client associated with a first user account of a communication platform that is associated with a first user, an indication of selection of a code, such as code 322, code 403, and/or code 504. In some examples, the indication of selection of the code can include an indication that the first user input the code, such as via an input/output device associated with the first client. In the illustrative example, the first user inputs the code by scanning the code with a camera associated with the first client, such as camera 320. In other examples, the first user can input the code by typing the code into a keyboard, verbally inputting the code, or the like.

In various examples, the communication platform can receive data associated with the code and/or the indication of selection thereof. For example, the first user can scan the code with the user computing device and the user computing device sends data associated with the code to the communication platform. In some examples, based on the data, the communication platform can determine one or more characteristics associated with the code. The characteristic(s) can include a location, a work shift status (e.g., check-in, check-out, on break, at lunch, etc.), a workflow, a step in a workflow, one or more communication channels associated with the code and/or the workflow, a bandwidth limitation associated with the code, or the like.

At operation 604, the communication platform determines whether the code is associated with a user status (e.g., on shift, on break, off shift, etc.), such as based on the data and/or characteristic(s) associated therewith. A code that is associated with a user status can include a work shift code, as described herein. In some examples, the communication platform compares data associated with the code to code data stored in a datastore (e.g. datastore 126) to determine whether the code is associated with a user status. The user status can include a working status, such as whether the user is clocking in on-shift at a job and/or location, is clocking out on a break (e.g., short break, meal break, etc.), clocking out off-shift, or the like.

Based on a determination that the code is associated with the user status (“Yes” at operation 604), the communication platform, at operation 606, identifies a first channel associated with at least one of the code or the user status. The first channel can be a channel that is associated with the code. In various examples, the first channel can include a channel that is associated with a location, position, title, and/or work shift that the user is checking in on. In some examples, the communication platform can identify the first channel based on the first user account associated with the indication of selection of the code. In such examples, the communication platform can identify the first user account associated with the user and can identify the code based on data associated therewith.

At operation 608, the communication platform causes a presentation, via the first client, of a first indicator associated with the first channel. The first indicator can be presented in association with a workflow interface and/or a sub-section of a region of an interface (e.g., third sub-section 212) as described above. In various examples, the communication platform enables the first user access to the first channel based on the indication of selection of the code. In such examples, responsive to receiving the indication of selection of the code from the first user account, the communication platform can modify permissions associated with the first channel and/or the first user account to grant the first user account access to the first channel.

Based on a determination that the code is associated with the user status (“Yes” at operation 604), the communication platform, at operation 610, identifies a workflow associated with the code. The workflow can be a sequence of steps in processing a unit of work from initiation to completion. As discussed above, one or more codes can be associated with steps in the workflow. For example, a first code can be associated with a first step, a second code can be associated with a second step, and so on. In various examples, the communication platform can determine the step in the workflow that is associated with the code.

At operation 612, the communication platform determines whether a second channel associated with the workflow exists. The second channel can include a communication channel associated with documenting information about the workflow, such as completion of steps, images associated with the workflow, dialogue about the workflow, and the like.

Based on a determination that the second channel associated with the workflow exists (“Yes” at operation 612), the communication platform, at operation 614, causes a presentation, on the first client, of a second indicator associated with the second channel. The second indicator can be presented in association with a workflow interface and/or a sub-section of a region of an interface (e.g., third sub-section 212), as described above. In some examples, the first user account can be granted permissions to access the second channel based on the indication of selection of a work shift code (e.g., check-in work shift code). In various examples, the communication platform enables the first user access to the second channel based on the indication of selection of the code. In such examples, responsive to receiving the indication of selection of the code from the first user account, the communication platform can modify permissions associated with the second channel and/or the first user account to grant the first user account access to the second channel.

At operation 616, the communication platform causes a presentation, on the first client via the second channel of a message associated with the code. In some examples, the communication platform can generate and transmit the message via the second channel in response to receiving the indication of selection of the code and/or data associated therewith. In some examples, the communication platform can automatically generate and transmit the message, such as without further input from a user associated with the second channel.

The message can include data associated with the code and/or a selection thereof. In at least one example, the message can include an indication that a step in the workflow associated with the code is complete. In various examples, the communication platform can identify a next step in the workflow that follows the step associated with the code. In such examples, the message can include an indication of the next step. In various examples, the communication platform can identify one or more users associated with the next step. In such examples, the message can include identifiers associated with the user(s) associated with the next step. For example, the communication platform can @mention or otherwise tag the user(s) in the message. Additionally or alternatively, the communication platform can generate and send a direct message to the user(s) associated with the next step, such as to inform the user(s) that the step in the workflow is complete and that the user(s) are responsible for the next step.

Based on a determination that the second channel associated with the workflow exists (“Yes” at operation 612), the communication platform, at operation 618, generates the second channel. In various examples, the communication platform identifies one or more users associated with the workflow. The user(s) can include workers, managers, customers, and/or the like. Based on the identification of the user(s), the communication platform can associate the user(s) with the newly generated second communication channel.

At operation 620, the communication platform causes a presentation, on the first client, of the second indicator associated with the second channel.

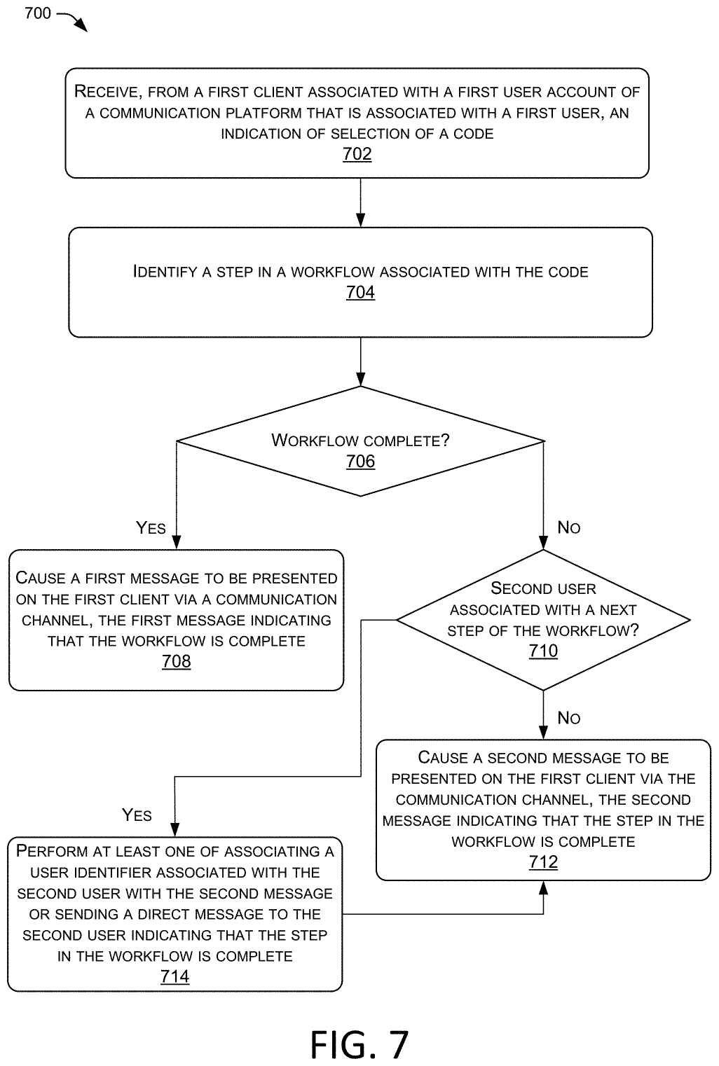

FIG. 7 illustrates an example process for presenting a completion of a step in a workflow via a communication channel based on an indication of selection of a code. In some instances, some or all of process 700 can be performed by one or more components in the system 100. By way of example and not limitation, the communication platform referred to in process 700 can be representative of a computing device associated with the (communication platform) server(s) 102, a client referred to in process 700 can be representative of the user computing device(s) 104 and/or application 130. However, the process 700 is not limited to being performed by the system 100.

At operation 702, the communication platform receives, from a first client associated with a first user account of a communication platform that is associated with a first user, an indication of selection of a code, such as code 322, code 403, and/or code 504. In some examples, the indication of selection of the code can include an indication that the first user input the code, such as via an input/output device associated with the first client. In the illustrative example, the first user inputs the code by scanning the code with a camera associated with the first client, such as camera 320. In other examples, the first user can input the code by typing the code into a keyboard, verbally inputting the code, or the like.

In various examples, the communication platform can receive data associated with the code and/or the indication of selection thereof. For example, the first user can scan the code with the user computing device and the user computing device sends data associated with the code to the communication platform. In some examples, based on the data, the communication platform can determine one or more characteristics associated with the code. The characteristic(s) can include a location, a work shift status (e.g., check-in, check-out, on break, at lunch, etc.), a workflow, a step in a workflow, one or more communication channels associated with the code and/or the workflow, a bandwidth limitation associated with the code, or the like.

At operation 704, the communication platform identifies a step in a workflow associated with the code. The communication platform can identify the step in the workflow based on the data and/or characteristics associated with the code. The workflow can be a sequence of steps in processing a unit of work from initiation to completion and the code can be associated with a particular step in the workflow. For example, a first code can be associated with a first step, a second code can be associated with a second step, and so on.

At operation 706, the communication platform determines whether the workflow is complete. In various examples, the communication determines completion of the workflow based on a determination that the step in the workflow associated with the code is a last step in the workflow.

Based on a determination that the workflow is complete (“Yes” at operation 706), the communication channel, at operation 708, causes a first message to be presented on the first client via a communication channel associated with the workflow, the first message indicating that the workflow is complete. The first message can include a message that is generated and transmitted by the communication platform based on the indication of selection of the code, such as without additional input from a user. In some examples, based on a determination that the workflow is complete, the communication platform can remove an indicator associated with the communication channel from a first interface associated with the first client and a second interface associated with a second client of a second user associated with the communication channel. In various examples, the communication platform can withhold data associated with the communication channel from presentation to the first user and the second user (e.g., members of the communication channel) based on a determination that the workflow is complete. In such examples, the communication platform can be configured to reduce a total amount of data transmitted via a network and/or can reduce clutter on the interfaces associated with members of the communication channel, thereby improving a user experience with the interface. In various examples, the communication platform can dissociate the first user and the second user (e.g., user accounts associated therewith) from the communication channel based on the determination that the workflow is complete. In some examples, based on a dissociation of the respective user accounts from the communication channel, the communication platform can remove an indicator associated with the communication channel from respective interfaces associated with the communication platform on a first client of the first user and a second client of the second user.

Based on a determination that the workflow is not complete (“No” at operation 706), the communication channel, at operation 710, determines whether a second user is associated with a next step of the workflow. The next step can include a step that immediately follows (in the sequence) the step identified at operation 704. The second user can be identified based on a position and/or title, a work location, a current location associated with the second user (e.g., based on location data associated with a user computing device), a work status associated with the second user (e.g., on-shift, not on a break, etc.), and the like.

Based on a determination that the second user is not associated with the workflow (“No” at operation 710), the communication channel, at operation 712, causes a second message to be presented on the first client via the communication channel, the second message indicating that the step in the workflow is complete. The second message can include data associated with the code, such as a timestamp (e.g., date, time, etc.) of code input, a user identifier associated with the first user, a location associated with the code input, an indication of the step in the workflow, a next step (e.g., next step that follows the step associated with the code), and/or the like.

Based on a determination that the second user is associated with the workflow (“Yes” at operation 710), the communication channel, at operation 714, performs at least one of associating a user identifier associated with the second user with the second message or sending a direct message to the second user indicating that the step in the workflow is complete. In various examples, the communication platform can associate the second user with the second message by including an @mention or otherwise tagging the second user in the second message. In various examples, the second message and/or the direct message can include an indication of the next step for the second user to perform and/or an instruction to perform the next step. After associating the user identifier associated with the second user with the second message and/or sending the direct message, the communication channel can cause the second message to be presented on the first client via the communication channel, the second message indicating that the step in the workflow is complete, as described with regard to operation 712.

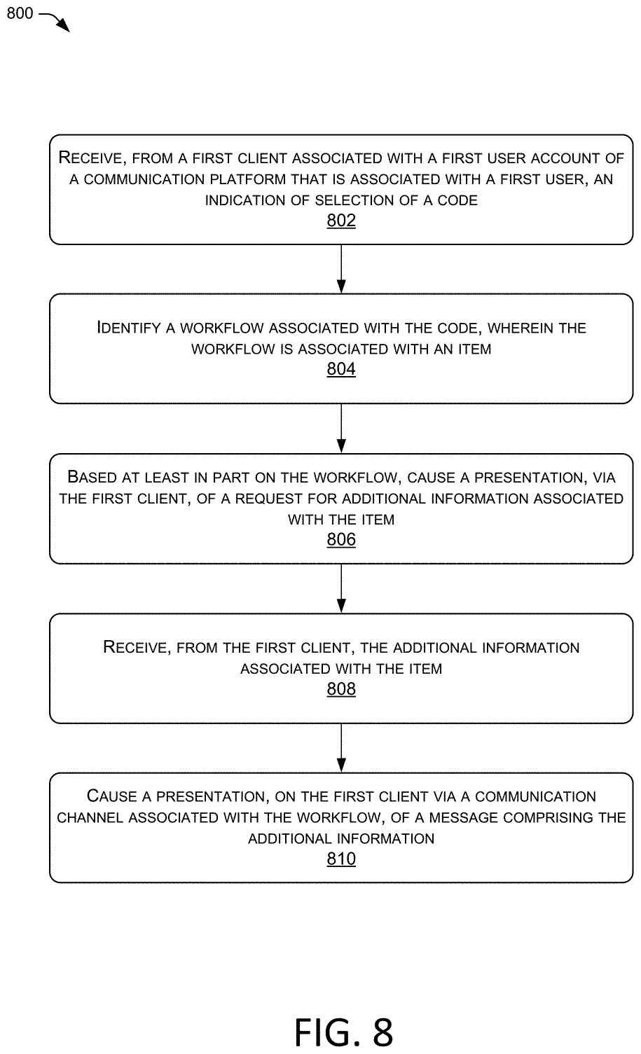

FIG. 8 illustrates an example process for documenting, via a communication channel, a completion of a step in a workflow with an image of an item or a file attachment. In some instances, some or all of process 800 can be performed by one or more components in the system 100. By way of example and not limitation, the communication platform referred to in process 800 can be representative of a computing device associated with the (communication platform) server(s) 102, a client referred to in process 800 can be representative of the user computing device(s) 104 and/or application 130. However, the process 800 is not limited to being performed by the system 100.

At operation 802, the communication platform receives, from a first client associated with a first user account of a communication platform that is associated with a first user, an indication of selection of a code, such as code 322, code 403, and/or code 504. In some examples, the indication of selection of the code can include an indication that the first user input the code, such as via an input/output device associated with the first client. In the illustrative example, the first user inputs the code by scanning the code with a camera associated with the first client, such as camera 320. In other examples, the first user can input the code by typing the code into a keyboard, verbally inputting the code, or the like.

In various examples, the communication platform can receive data associated with the code and/or the indication of selection thereof. For example, the first user can scan the code with the user computing device and the user computing device sends data associated with the code to the communication platform. In some examples, based on the data, the communication platform can determine one or more characteristics associated with the code. The characteristic(s) can include a location, a work shift status (e.g., check-in, check-out, on break, at lunch, etc.), a workflow, a step in a workflow, one or more communication channels associated with the code and/or the workflow, a bandwidth limitation associated with the code, or the like.

At operation 804, the communication platform identifies a workflow associated with the code, wherein the workflow is associated with an item. The workflow can be a sequence of steps in processing the item from initiation to completion of a process. As non-limiting examples, the workflow can include a process of packaging and delivering an item to a customer, stocking and selling an item in a retail environment, and the like.

At operation 806, based at least in part on the workflow, the communication platform causes a presentation, via the first client, of a request for additional information associated with the item and/or workflow. The additional information can include an image (e.g., photograph, video, etc.), a description of an item and/or condition, security, etc. thereof, detected flaws in packaging, detected flaws in the item, and the like. In various examples, based on the workflow, the communication platform can determine that additional information associated with the item is required for documentation. In some examples, the determination can be based on a workflow type associated with the workflow, an organization setting stored in a datastore (e.g., organization preference to document information associated with a workflow, etc.), a value of the item, a customer request to receive updates associated with the item, and/or the like.

At operation 808, the communication platform receives, from the first client, the additional information associated with the item. In various examples, the communication platform can determine whether the additional information received satisfies a requirement for the additional information (e.g., the received additional information meets a threshold requirement). Based on a determination that the additional information does not satisfy the requirement, the communication platform can cause another request for updated additional information to be presented via the first client. In some examples, the communication platform can request updated data until determining that the requirement is satisfied. In some examples, the communication platform can be configured to request additional information a threshold number of times. After the additional information has been requested the threshold number of times without satisfaction, the communication platform can cause an error message to be presented via a communication channel associated with the workflow and/or via a direct message or notification to a manager (e.g., on-shift manager) associated with the workflow. Based on a determination that the additional information satisfies the requirement, the communication platform can store the additional information in association with the data and/or characteristic(s) of the code.

At operation 810, the communication platform causes a presentation, on the first client via a communication channel associated with the workflow, of a message comprising the additional information. In some examples, the message can include a message indicating that a step in the workflow is complete, such as that described above with regard to operation 616, 708, and/or 712. In such examples, the message can include a first message generated by the communication platform based on the indication of selection of the code, as described above, the first message including the data and/or characteristics associated with the indication of selection of the code. In some examples, the communication platform can generate a second message including the additional information and can cause the additional message to be transmitted via the communication channel, such as in association with the first message. In some examples, the second message including the additional information can be presented in a thread associated with the first message.

In various examples, the communication platform can identify an administrative user associated with the communication channel and/or the workflow. The administrative user can include an employee manager, a workflow manager, a supervisor, and/or other user associated with an administrative position. In some examples, the communication platform can enable the administrative user access to the communication channel throughout the workflow and/or after the workflow is complete. For example, the administrative user can access the communication channel to determine a status of the workflow while the workflow is in process. For another example, the administrative user can be granted access to the communication channel after completion of the workflow. In such an example, the administrative user can manage the documentation associated with completed workflows, such as to perform post-mortems on completed workflows. In various examples, the administrative user can submit a request to view a communication channel associated with the completed workflow, such as via a search mechanism (e.g., search mechanism 216, search mechanism 314, etc.). In response to receiving the request, the communication platform can cause a presentation of data associated with the communication channel via a client associated with the administrative user.

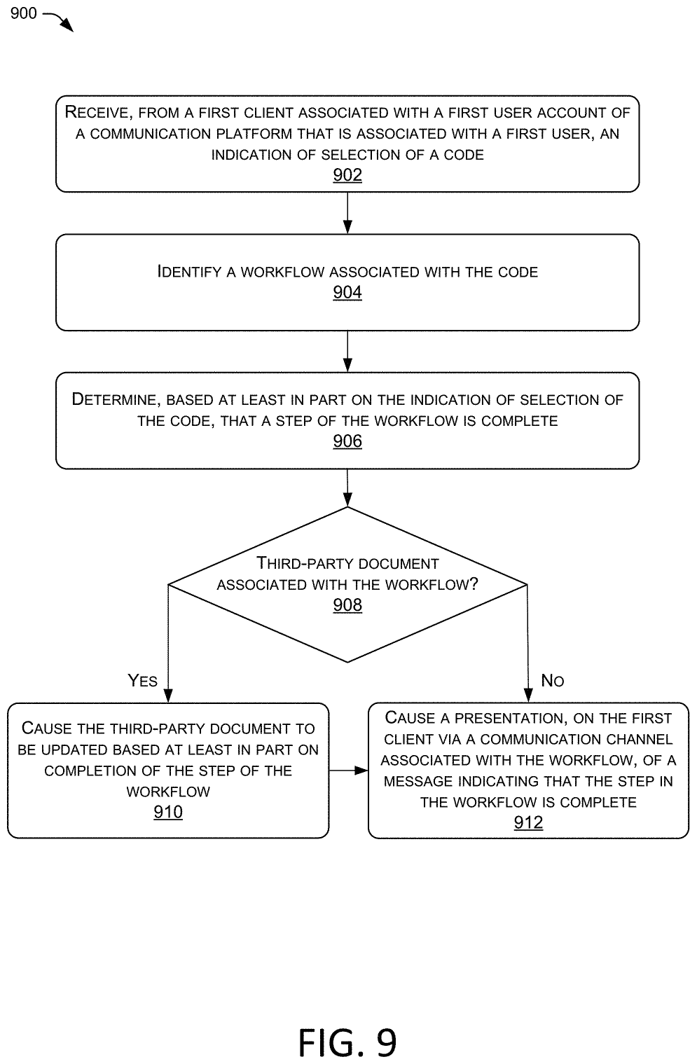

FIG. 9 illustrates an example process for updating a third-party document based on an indication of selection of a code, utilizing the techniques described herein. In some instances, some or all of process 900 can be performed by one or more components in the system 100. By way of example and not limitation, the communication platform referred to in process 900 can be representative of a computing device associated with the (communication platform) server(s) 102, a client referred to in process 900 can be representative of the user computing device(s) 104 and/or application 130. However, the process 900 is not limited to being performed by the system 100.

At operation 902, the communication platform receives, from a first client associated with a first user account of a communication platform that is associated with a first user, an indication of selection of a code, such as code 322, code 403, and/or code 504. In some examples, the indication of selection of the code can include an indication that the first user input the code, such as via an input/output device associated with the first client. In the illustrative example, the first user inputs the code by scanning the code with a camera associated with the first client, such as camera 320. In other examples, the first user can input the code by typing the code into a keyboard, verbally inputting the code, or the like.

In various examples, the communication platform can receive data associated with the code and/or the indication of selection thereof. For example, the first user can scan the code with the user computing device and the user computing device sends data associated with the code to the communication platform. In some examples, based on the data, the communication platform can determine one or more characteristics associated with the code. The characteristic(s) can include a location, a work shift status (e.g., check-in, check-out, on break, at lunch, etc.), a workflow, a step in a workflow, one or more communication channels associated with the code and/or the workflow, a bandwidth limitation associated with the code, or the like.

At operation 904, the communication platform identifies a workflow associated with the code. The workflow can be a sequence of steps in processing a unit of work from initiation to completion. As discussed above, one or more codes can be associated with steps in the workflow. For example, a first code can be associated with a first step, a second code can be associated with a second step, and so on. In various examples, the communication platform can determine the step in the workflow that is associated with the code.

At operation 906, the communication platform determines, based at least in part on the indication of selection of the code, that a step of the workflow is complete. In various examples, the communication platform determines that the step in the workflow is complete based in part on the data and/or characteristic(s) associated with the code.

At operation 908, the communication platform determines whether a third-party document, such as third-party document 134, is associated with the workflow. The third-party document 134 can include a document that is managed by a third-party service provider, such as third-party service provider 108, and is configured to store data associated with one or more workflows. That is, the third-party document 134 can provide a means of documenting data associated with steps of the workflow as the steps are completed.

Based on a determination that a third-party document is associated with the workflow (“Yes” at operation 908), the communication platform, at operation 910, causes the third-party document to be updated based at least in part on completion of the step of the workflow. In some examples, the communication platform can provide data and/or characteristic(s) to the third-party service provider, with an instruction to update the third-party document based on the data and/or characteristic(s). For example, the communication platform can send an instruction to the third-party service provider to update the third-party document with a timestamp associated with completion of the step. In some examples, the communication platform can additionally provide additional information associated with the step, such as that described above. In such examples, the third-party document can be updated to include the additional information. For example, a customer who ordered an item can access the third-party document to determine information about the item, such as where the item is in the process of packaging and delivery, a condition of the item, and the like.

Based on a determination that a third-party document is not associated with the workflow (“No” at operation 908) and/or after completing operation 910, the communication platform, at operation 912, causes a presentation, on the first client via a communication channel associated with the workflow, of a message indicating that the step in the workflow is complete. In some examples, the communication platform can generate and transmit the message via the communication channel in response to receiving the indication of selection of the code and/or data associated therewith. In some examples, the communication platform can automatically generate and transmit the message, such as without further input from a user associated with the communication channel.

The message can include data and/or characteristic(s) associated with the code and/or a selection thereof. In various examples, the communication platform can identify a next step in the workflow that follows the step associated with the code. In such examples, the message can include an indication of the next step. In various examples, the communication platform can identify one or more users associated with the next step. In such examples, the message can include identifiers associated with the user(s) associated with the next step. For example, the communication platform can @mention or otherwise tag the user(s) in the message. Additionally or alternatively, the communication platform can generate and send a direct message to the user(s) associated with the next step, such as to inform the user(s) that the step in the workflow is complete and that the user(s) are responsible for the next step.

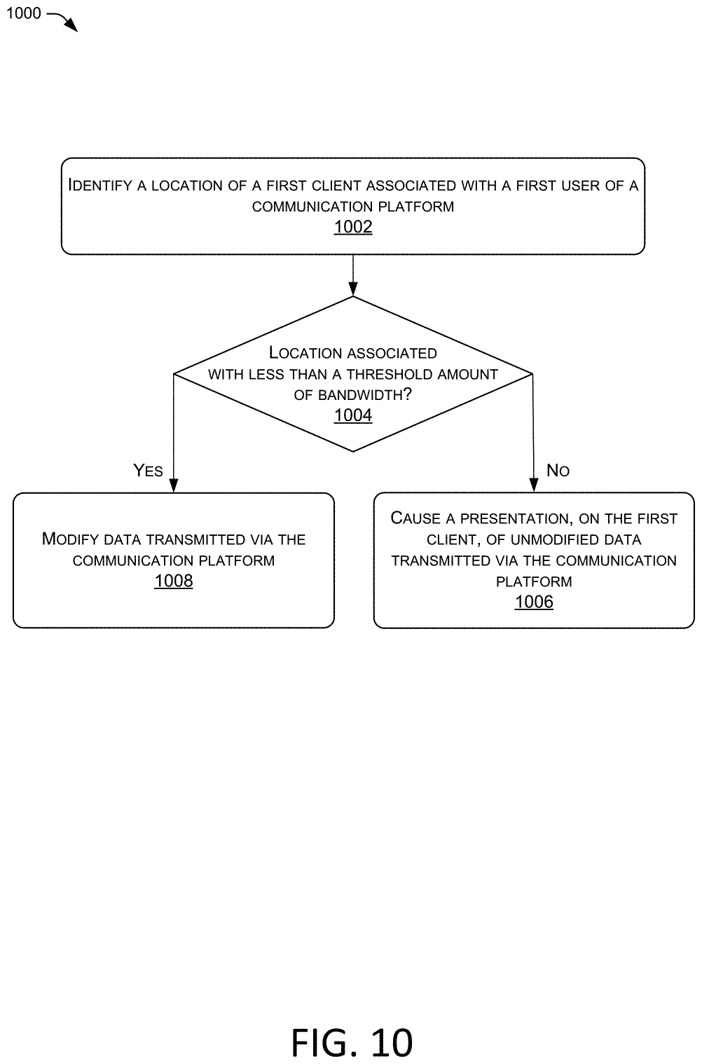

FIG. 10 illustrates an example process for optimizing a communication application based on available bandwidth. In some instances, some or all of process 1000 can be performed by one or more components in the system 100. By way of example and not limitation, the communication platform referred to in process 1000 can be representative of a computing device associated with the (communication platform) server(s) 102, a client referred to in process 1000 can be representative of the user computing device(s) 104 and/or application 130. However, the process 1000 is not limited to being performed by the system 100.

At operation 1002, the communication platform identifies a location of a first client associated with a first user of a communication platform. In some examples, the communication platform can determine the location based on receiving an indication of selection of a code associated with the location. For example, the first user can check-in to a particular location by scanning a code associated with the particular location. The communication platform can receive an indication of selection of the code (e.g., indication that the code was scanned) and data associated with the code. The communication platform can determine one or more characteristics associated with the code, such as a corresponding location thereof.

In some examples, the communication platform can be configured to receive location data associated with the first client, such as that determined by a location component associated with the first client. The location component can include a GPS, Wi-Fi network identifier, triangulation system, gyroscopes, inertial measurement unit, and/or other component configured to determine a location of a device.

At operation 1004, the communication platform determines whether the location is associated with less than a threshold amount of bandwidth. The threshold amount of bandwidth can include a predetermined amount of bandwidth associated with enabling full functionality of an instance of a communication application. For example, the threshold amount of bandwidth can include the bandwidth associated with transmitting messages, animations, images, audio files, video files, and the like in real-time and/or near real-time.

In various examples, the communication platform determines whether the location is associated with less than the threshold amount of bandwidth based on data stored in association with the location, such as in a datastore (e.g., datastore 126). For example, the communication platform can receive an indication that the location has limited bandwidth and can store an indication thereof in the datastore, such as in association with code data corresponding to one or more codes associated with the location. In various examples, the communication platform determines whether the location is associated with less than the threshold amount of bandwidth based on a determined signal strength recognized by the first client and/or a device associated therewith. In some examples, the communication platform determines whether the location is associated with less than the threshold amount of bandwidth based on a determination of a Wi-Fi network to which the first client is connected.

Based on a determination that the bandwidth at the location meets or exceeds the threshold amount of bandwidth (“No” at operation 1004), the communication platform, at operation 1006, causes a presentation, on the first client, of unmodified data transmitted via the communication platform. In various examples, the unmodified data can include data as originally sent via the communication platform.

Based on a determination that the bandwidth at the location is less than the threshold amount of bandwidth (“Yes” at operation 1004), the communication platform, at operation 1008, modifies data transmitted via the communication platform. In some examples, a modification to the data can include providing updates (e.g., new messages, reaction emojis, data, etc.) transmitted via select virtual spaces of the communication platform while withholding updates (e.g., not transmitting to the first client) updates transmitted via other virtual spaces. That is, the communication platform can mute or otherwise silence the other virtual spaces based on the limited bandwidth environment. In some examples, the data modification can include changes to the data transmitted, such as by collapsing images, suppressing animations, splitting files into segments (e.g., <2 megabytes, <4 megabytes or less, etc.) for transmission, compressing audio files, and the like.

In some examples, the communication platform can identify a first set of communication channels associated with the location. In some examples, the communication platform can cause updates associated with the first set of communication channels to be presented via the first client, while withholding updates associated with other communication channels. In such examples, the communication platform can modify a total amount of data transmitted to (and from) the first client while operating in the limited bandwidth environment. As discussed above, the first set of communication channels can additionally include one or more communication channels that are designated by the first user to be continually updated, such as in a user preference of the first user. In some examples, the communication channel(s) designated by the first user can include those in which the first user is actively engaging in, frequently engages with, is frequently mentioned, frequently mentions other users, and the like. In such examples, the communication platform can determine the first set of communication channels based on user engagement and/or interactions with one or more communication channels.

In various examples, the communication platform can be configured to identify the amount of bandwidth available at the location. In some examples, the communication platform can determine modifications to the data (e.g., a number of communication channels to be updated, the types of updates, collapsing images, suppressing animations, splitting files, compressing audio files, etc.) based on the amount of available bandwidth. In some examples, the communication platform can compare the amount of bandwidth to one or more thresholds to determine the modifications. For example, based on a determination that the available bandwidth is less than a first threshold, the communication platform can provide updates to a first number of communication channels, the updates including modified data (e.g., suppressed animations, collapsed images, etc.). Based on a determination that the available bandwidth is equal to or greater than the first threshold, but less than a second threshold, the communication platform can provide updates to a second number of communication channels, the second number being greater than the first number, and the updates including modified data. Based on a determination that the available bandwidth is equal to or greater than the second threshold, but less than a third threshold, the communication platform can provide updates to a third number of communication channels, the updates including unmodified data. Based on a determination that the available bandwidth is equal to or greater than a fourth threshold, the communication platform can provide updates for all communication channels of which the first user is a member.

In various examples, the communication platform can continue to modify the data transmitted via the virtual space(s) and/or can provide updates associated with select virtual space(s) until the communication platform receives an indication that the first client is no longer operating in the limited bandwidth environment. In some examples, the communication platform can receive the indication, such as in response to receiving an indication that the first user scanned a code associated with checking out of the limited bandwidth location, a code associated with non-limited bandwidth location (e.g., another location that is not bandwidth limited), and/or an indication from the location component that the first client is no longer associated with the limited-bandwidth location, and/or the like.

Additionally or alternatively, the communication platform can modify storage of data input via an instance of the communication application based on a determination that the first user is operating in a limited bandwidth environment. In some examples, the communication platform can store data associated with the code locally on a datastore of the user computing device. In some examples, the communication platform can store data on another computing device located proximate (e.g., on a premises of, in a building with, etc.) the first user and/or other users associated with the communication channel. In some examples, the other computing device and the user computing device(s) associated with the first user and/or other users can be connected via a local network, such as via Bluetooth, or other near-field communication connection. In some examples, the communication platform can cause the other computing device to sync data associated with the communication channels with the user computing device(s), such as to enable updates and data synchronization between relevant computing device(s) associated with a location, workflow, communication channel, workspace, or the like.

Though described primarily as modifying data associated with communication channels based on limited bandwidth, this is not intended to be so limiting and the data modification can include modifications to data transmitted via other virtual spaces, such as direct messaging instances and the like. Additionally, though described primarily as modifying data transmitted via a communication platform based on limited bandwidth, this is not intended to be so limiting and the same or similar techniques can be utilized in an environment of increased information security, such as operating in a sensitive compartmented information facility (SCIF), or other environment in which data transmission via disparate sources may be monitored and/or controlled. For example, in response to determining that a user is going to enter a SCIF based on receiving a code associated therewith and/or identity authentication of the user, the communication platform can enable the user access to one or more first virtual spaces associated with the SCIF and disable access to one or more second virtual spaces associated with the communication platform of which the user is a member, but not associated with the SCIF. As such, the user can transmit and receive data via the first virtual space(s) when located in the SCIF, but may not be able to communicate and/or view data associated with the second (disabled) virtual space(s). In response to determining that the user has departed the SCIF, such as based on receiving location information associated with the user computing device, receiving an indication of selection of another code associated with checking out of the SCIF, or the like, the communication platform can revoke access to the first virtual space(s) associated with the SCIF and enable access to the second virtual space(s).

### Example Clauses

A: A method comprising: receiving, from a first client associated with a first user of a communication platform, an indication of selection of a code by the first user; triggering a workflow associated with the code; determining, based at least in part on the indication of selection of the code, that a first step in the workflow is complete; identifying a communication channel of the communication platform that is associated with the workflow; and causing a presentation of a message in the communication channel on the first client associated with the first user and a second client associated with a second user of the communication platform, wherein the message includes a notification that the first step in the workflow has been completed.

B: The method of paragraph A, further comprising: in response to receiving the indication of selection of the code by the first user, generating the communication channel through the workflow; associating a first user account of first user and a second user account of the second user with the communication channel; and causing an indicator associated with the communication channel to be presented via a first interface associated with the first client and a second interface associated with the second client.

C: The method of paragraph B, wherein the code is a first code, the method further comprising: receiving, from the second client, an indication that a second code has been selected by the second user, the second code being associated with a second step in the workflow; and based at least in part on a determination that the workflow is complete based in part on the indication that the second code has been selected by the second user, dissociating a first user account of the first user and a second user account of the second user from the communication channel.

D: The method of paragraph C, further comprising, based at least in part on a dissociation of the first user account and the second user account from the communication channel, removing the indicator associated with the communication channel from the first interface associated with the first client and the second interface associated with the second client.

E: The method of any one of paragraphs A-D, wherein: the first user is associated with a first organization; and the second user is associated with a second organization that is different from the first organization.

F: The method of any one of paragraphs A-E, further comprising: receiving, from a third client associated with a third user of the communication platform, a request to access data associated with the communication channel; identifying the third user as an administrative user of the communication platform; and based at least in part on a determination that the third user is the administrative user, causing a presentation of the data associated with the communication channel via the third client.

G: The method of any one of paragraphs A-F, further comprising: in response to receiving the indication of selection of the code by the first user, causing a presentation, via the first client, of a request for additional data associated with the workflow, wherein the additional data provides documentation of a condition of the first step in the workflow; receiving, from the first client, the additional data associated with the workflow; and causing a presentation of the additional data in association with the message on the first client associated with the first user and a second client associated with a second user of the communication platform.

H: The method of any one of paragraphs A-G, further comprising: identifying a location associated with at least one of the code or the first client at a time associated with the indication of selection of the code; and determining, based at least in part on the location, that the first step in the workflow is complete.

I: A system comprising: one or more processors; and one or more non-transitory computer readable media storing instructions that, when executed, cause the system to: receive, from a first client associated with a first user of a communication platform, an indication of selection of a code by the first user; trigger a workflow associated with the code; determine, based at least in part on the indication of selection of the code, that a first step in the workflow is complete; identify a communication channel of the communication platform that is associated with the workflow; and cause a presentation of a message in the communication channel on the first client associated with the first user and a second client associated with a second user of the communication platform, wherein the message includes a notification that the first step in the workflow has been completed.

J: The system of paragraph I, wherein the instructions further cause the system to: in response to receiving the indication of selection of the code by the first user, generate the communication channel through the workflow; associate a first user account of first user and a second user account of the second user with the communication channel; and cause an indicator associated with the communication channel to be presented via a first interface associated with the first client and a second interface associated with the second client.

K: The system of paragraph J, wherein the code is a first code and the instructions further cause the system to: receive, from the second client, an indication that a second code has been selected by the second user, the second code being associated with a second step in the workflow; and based at least in part on a determination that the workflow is complete based in part on the indication that the second code has been selected by the second user, dissociate a first user account of the first user and a second user account of the second user with the communication channel.

L: The system of any one of paragraphs I-K, wherein: the first user is associated with a first organization; and the second user is associated with a second organization that is different from the first organization.

M: The system of any one of paragraphs I-L, wherein the instructions further cause the system to: receive, from a third client associated with a third user of the communication platform, a request to access data associated with the communication channel; identify the third user as an administrative user of the communication platform; and based at least in part on a determination that the third user is the administrative user, cause a presentation of the data associated with the communication channel via the third client.

N: The system any one of paragraphs I-M, wherein the instructions further cause the system to: in response to receiving the indication of selection of the code by the first user, cause a presentation, via the first client, of a request for additional data associated with the workflow, wherein the additional data provides documentation of a condition of the first step in the workflow; receive, from the first client, the additional data associated with the workflow; and cause a presentation of the additional data in association with the message on the first client associated with the first user and a second client associated with a second user of the communication platform.

O: The system of any one of paragraphs I-N, wherein the instructions further cause the system to: identify a location associated with at least one of the code or the first client at a time associated with the indication of selection of the code; and determine, based at least in part on the location, that the first step in the workflow is complete.

P: One or more non-transitory computer readable media storing instructions that, when executed, cause one or more processors to: receive, from a first client associated with a first user of a communication platform, an indication of selection of a code by the first user; trigger a workflow associated with the code; determine, based at least in part on the indication of selection of the code, that a first step in the workflow is complete; identify a communication channel of the communication platform that is associated with the workflow; and cause a presentation of a message in the communication channel on the first client associated with the first user and a second client associated with a second user of the communication platform, wherein the message includes a notification that the first step in the workflow has been completed.

Q: The one or more non-transitory computer readable media of paragraph P, wherein the instructions further cause the one or more processors to: in response to receiving the indication of selection of the code by the first user, generate the communication channel through the workflow; associate a first user account of first user and a second user account of the second user with the communication channel; and cause an indicator associated with the communication channel to be presented via a first interface associated with the first client and a second interface associated with the second client.

R: The one or more non-transitory computer readable media of paragraph Q, wherein the code is a first code and the instructions further cause the one or more processors to: receive, from the second client, an indication that a second code has been selected by the second user, the second code being associated with a second step in the workflow; and based at least in part on a determination that the workflow is complete based in part on the indication that the second code has been selected by the second user, dissociate a first user account of the first user and a second user account of the second user with the communication channel.

S: The one or more non-transitory computer readable media of any one of paragraphs P-R, wherein: the first user is associated with a first organization; and the second user is associated with a second organization that is different from the first organization.

T: The one or more non-transitory computer readable media of any one of paragraphs P-S, wherein the instructions further cause the one or more processors to: receive, from a third client associated with a third user of the communication platform, a request to access data associated with the communication channel; identify the third user as an administrative user of the communication platform; and based at least in part on a determination that the third user is the administrative user, cause a presentation of the data associated with the communication channel via the third client.

While the example clauses described above are described with respect to one particular implementation, it should be understood that, in the context of this document, the content of the example clauses may also be implemented via a method, device, system, a computer-readable medium, and/or another implementation.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, from a first client associated with a first user of a communication platform, an indication of selection of a code by the first user;
triggering a workflow associated with the code;
determining, based at least in part on the indication of selection of the code, that a first step in the workflow is complete;
identifying a communication channel of the communication platform that is associated with the workflow; and
causing a presentation of a message in the communication channel on the first client associated with the first user and a second client associated with a second user of the communication platform, wherein the message includes a notification that the first step in the workflow has been completed.

2. The method of claim 1, further comprising:
in response to receiving the indication of selection of the code by the first user,
generating the communication channel through the workflow;
associating a first user account of first user and a second user account of the second user with the communication channel; and
causing an indicator associated with the communication channel to be presented via a first interface associated with the first client and a second interface associated with the second client.

3. The method of claim 2, wherein the code is a first code, the method further comprising:
receiving, from the second client, an indication that a second code has been selected by the second user, the second code being associated with a second step in the workflow; and
based at least in part on a determination that the workflow is complete based in part on the indication that the second code has been selected by the second user, dissociating a first user account of the first user and a second user account of the second user from the communication channel.

4. The method of claim 3, further comprising, based at least in part on a dissociation of the first user account and the second user account from the communication channel, removing the indicator associated with the communication channel from the first interface associated with the first client and the second interface associated with the second client.

5. The method of claim 1, wherein:
the first user is associated with a first organization; and
the second user is associated with a second organization that is different from the first organization.

6. The method of claim 1, further comprising:
receiving, from a third client associated with a third user of the communication platform, a request to access data associated with the communication channel;
identifying the third user as an administrative user of the communication platform; and
based at least in part on a determination that the third user is the administrative user, causing a presentation of the data associated with the communication channel via the third client.

7. The method of claim 1, further comprising:
in response to receiving the indication of selection of the code by the first user,
causing a presentation, via the first client, of a request for additional data associated with the workflow, wherein the additional data provides documentation of a condition of the first step in the workflow;
receiving, from the first client, the additional data associated with the workflow; and
causing a presentation of the additional data in association with the message on the first client associated with the first user and a second client associated with a second user of the communication platform.

8. The method of claim 1, further comprising:
identifying a location associated with at least one of the code or the first client at a time associated with the indication of selection of the code; and
determining, based at least in part on the location, that the first step in the workflow is complete.

9. A system comprising:
one or more processors; and
one or more non-transitory computer readable media storing instructions that, when executed, cause the system to:
receive, from a first client associated with a first user of a communication platform, an indication of selection of a code by the first user;
trigger a workflow associated with the code;
determine, based at least in part on the indication of selection of the code, that a first step in the workflow is complete;
identify a communication channel of the communication platform that is associated with the workflow; and
cause a presentation of a message in the communication channel on the first client associated with the first user and a second client associated with a second user of the communication platform, wherein the message includes a notification that the first step in the workflow has been completed.

10. The system of claim 9, wherein the instructions further cause the system to:
in response to receiving the indication of selection of the code by the first user,
generate the communication channel through the workflow;
associate a first user account of first user and a second user account of the second user with the communication channel; and
cause an indicator associated with the communication channel to be presented via a first interface associated with the first client and a second interface associated with the second client.

11. The system of claim 10, wherein the code is a first code and the instructions further cause the system to:
receive, from the second client, an indication that a second code has been selected by the second user, the second code being associated with a second step in the workflow; and
based at least in part on a determination that the workflow is complete based in part on the indication that the second code has been selected by the second user, dissociate a first user account of the first user and a second user account of the second user with the communication channel.

12. The system of claim 9, wherein:
the first user is associated with a first organization; and
the second user is associated with a second organization that is different from the first organization.

13. The system of claim 9, wherein the instructions further cause the system to:
receive, from a third client associated with a third user of the communication platform, a request to access data associated with the communication channel;
identify the third user as an administrative user of the communication platform; and
based at least in part on a determination that the third user is the administrative user, cause a presentation of the data associated with the communication channel via the third client.

14. The system of claim 9, wherein the instructions further cause the system to:
in response to receiving the indication of selection of the code by the first user,
cause a presentation, via the first client, of a request for additional data associated with the workflow, wherein the additional data provides documentation of a condition of the first step in the workflow;
receive, from the first client, the additional data associated with the workflow; and
cause a presentation of the additional data in association with the message on the first client associated with the first user and a second client associated with a second user of the communication platform.

15. The system of claim 9, wherein the instructions further cause the system to:
identify a location associated with at least one of the code or the first client at a time associated with the indication of selection of the code; and
determine, based at least in part on the location, that the first step in the workflow is complete.

16. One or more non-transitory computer readable media storing instructions that, when executed, cause one or more processors to:
receive, from a first client associated with a first user of a communication platform, an indication of selection of a code by the first user;
trigger a workflow associated with the code;
determine, based at least in part on the indication of selection of the code, that a first step in the workflow is complete;
identify a communication channel of the communication platform that is associated with the workflow; and
cause a presentation of a message in the communication channel on the first client associated with the first user and a second client associated with a second user of the communication platform, wherein the message includes a notification that the first step in the workflow has been completed.

17. The one or more non-transitory computer readable media of claim 16, wherein the instructions further cause the one or more processors to:
in response to receiving the indication of selection of the code by the first user,
generate the communication channel through the workflow;
associate a first user account of first user and a second user account of the second user with the communication channel; and
cause an indicator associated with the communication channel to be presented via a first interface associated with the first client and a second interface associated with the second client.

18. The one or more non-transitory computer readable media of claim 17, wherein the code is a first code and the instructions further cause the one or more processors to:
receive, from the second client, an indication that a second code has been selected by the second user, the second code being associated with a second step in the workflow; and
based at least in part on a determination that the workflow is complete based in part on the indication that the second code has been selected by the second user, dissociate a first user account of the first user and a second user account of the second user with the communication channel.

19. The one or more non-transitory computer readable media of claim 16, wherein:
the first user is associated with a first organization; and
the second user is associated with a second organization that is different from the first organization.

20. The one or more non-transitory computer readable media of claim 16, wherein the instructions further cause the one or more processors to:
receive, from a third client associated with a third user of the communication platform, a request to access data associated with the communication channel;
identify the third user as an administrative user of the communication platform; and
based at least in part on a determination that the third user is the administrative user, cause a presentation of the data associated with the communication channel via the third client.
